(19) United States
(12) Patent Application Publication
(10) Pub. No.: US 2024/0118112 A1
(43) Pub. Date: Apr. 11, 2024

(54) APPARATUS AND METHOD FOR CONTEXTUAL INTERACTIONS ON INTERACTIVE FABRICS WITH INDUCTIVE SENSING

(71) Applicant: TRUSTEES OF DARTMOUTH COLLEGE, Hanover, NH (US)

(72) Inventors: Jun GONG, Hanover, NH (US); Alemayehu SEYED, Calgary, Alberta (CA); Xing-Dong YANG, Hanover, NH (US)

(73) Assignee: TRUSTEES OF DARTMOUTH COLLEGE, Hanover, NH (US)

(21) Appl. No.: 17/768,773

(22) PCT Filed: Oct. 16, 2020
(86) PCT No.: PCT/US2020/056134

§ 371 Date: Apr. 13, 2022

(51) Int. Cl. G01D 5/20; G01B 7/28; G06N 3/08; H01F 27/28

(52) U.S. Cl. CPC G01D 5/20; G01B 7/28; G06N 3/08; H01F 27/28

(57) ABSTRACT

A contact-based inductive sensing technique for contextual interactions on interactive fabrics is described. The technique recognizes conductive objects (mainly metallic) that are commonly found in households and workplaces, such as keys, coins, and electronic devices. An apparatus includes an array of a plurality of six by six spiral-shaped coils including conductive thread, sewn onto a four-layer fabric structure. The coil shape parameters were determined based on maximizing the sensitivity based on a new inductance approximation formula. Through a ten-participant study, the performance of sensing technique across 27 common objects was evaluated. A 93.9% real-time accuracy for object recognition resulted.

### CROSS REFERENCE TO RELATED APPLICATIONS

This present disclosure claims the benefit of U.S. Provisional Application No. 62/916,897, filed on Oct. 18, 2019, which is incorporated herein by reference in its entirety.

### FIELD

The present disclosure relates to a contact-based inductive sensing technique for contextual interactions on interactive fabrics.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Input through interactive textiles has found applications in clothing, fashion, furniture, toys, and even vehicles. Thus, it is foreseeable that objects that are already made or covered by soft and lightweight fabrics may become an important part of daily digital life in the near future. However, with current sensing techniques on interactive fabric, user input is limited to either touch or deformation of the fabric. As a result, opportunities for several new interaction techniques have thus been presented. Thus, an interactive sensing apparatus capable of accurate sensing of objects and even general user gestures is desired.

### SUMMARY

The present disclosure relates to an object recognition apparatus, including: a substrate formed of a textile; and at least one sensor including an inductive coil, the inductive coil including a conductive fiber, the inductive coil being sewn into the substrate, each of the at least one sensor configured to detect an object proximal to the at least one sensor via inductive coupling and output a signal based on a change in a resonant frequency of the at least one sensor.

The present disclosure further includes: processing circuitry configured to receive, from each of the at least one sensor, the signal based on the change in resonant frequency of the respective at least one sensor; and determine, based on the signal, an identity of the object.

The disclosure additionally relates to a method for object recognition, including: receiving a signal from at least one sensor, the at least one sensor including an inductive coil, the inductive coil including a conductive fiber, the inductive coil being sewn into a substrate formed of a textile, each of the at least one sensor configured to detect an object proximal to the at least one sensor via inductive coupling and output a signal based on a change in a resonant frequency of the at least one sensor; and determining, based on the signal, an identity of the object, wherein the signal generated is based on the change in resonant frequency of the respective at least one sensor.

Note that this summary section does not specify every embodiment and/or incrementally novel aspect of the present disclosure or claimed invention. Instead, this summary only provides a preliminary discussion of different embodiments and corresponding points of novelty. For additional details and/or possible perspectives of the invention and embodiments, the reader is directed to the Detailed Description section and corresponding figures of the present disclosure as further discussed below.

### BRIEF DESCRIPTION OF THE DRAWINGS

Various embodiments of this disclosure that are proposed as examples will be described in detail with reference to the following figures, wherein like numerals reference like elements, and wherein:

FIG. 1A is an optical image of a fabric-based interactive sensing apparatus that can detect conductive objects placed on it, according to an embodiment of the disclosure.

FIG. 1B is a schematic of the sensing apparatus including an object, according to an embodiment of the present disclosure.

FIGS. 2A-2D show environmental and artificial conductive objects and their inductive footprints, according to an embodiment of the disclosure.

FIG. 3 shows a four-layer structure including the sensing apparatus, according to an embodiment of the disclosure.

FIGS. 4A-4D show tested coils including different conductive threads, according to an embodiment of the disclosure.

FIGS. 5A-5D show designs of the spiral coils, according to an embodiment of the disclosure.

FIGS. 6A-6F show coils on different types of substrates, according to an embodiment of the disclosure.

FIG. 7 shows a sensing apparatus with a sensing board, according to an embodiment of the disclosure.

FIGS. 8A-8C show a splice used to connect a conductive thread to a wire, according to an embodiment of the disclosure.

FIGS. 9A-9C show a can and a heatmap of an inductance footprint of the can, according to an embodiment of the disclosure.

FIG. 10 shows objects tested, according to an embodiment of the disclosure.

FIG. 11 shows object confusion matrices, according to an embodiment of the present disclosure.

FIGS. 12A-12D show example applications, according to an embodiment of the present disclosure.

FIG. 13A illustrates a high-level framework for training a neural network for object recognition, according to an embodiment of the present disclosure.

FIG. 13B illustrate a low-level flow diagram for the object recognition process according to an embodiment of the present disclosure.

FIG. 13C shows an example of a general artificial neural network (ANN).

FIG. 14 shows a non-limiting example of a flow chart for a method of determining object identity according to an embodiment of the present disclosure

FIG. 15 is a block diagram of the sensing system including the sensing apparatus used in exemplary embodiments.

FIG. 16 illustrates a computer system.

FIG. 17 illustrates a data processing system.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “top,” “bottom,” “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The order of discussion of the different steps as described herein has been presented for clarity sake. In general, these steps can be performed in any suitable order. Additionally, although each of the different features, techniques, configurations, etc. herein may be discussed in different places of this disclosure, it is intended that each of the concepts can be executed independently of each other or in combination with each other. Accordingly, the present invention can be embodied and viewed in many different ways.

Techniques herein describe an interactive sensing apparatus utilizing contact-based inductive sensing for contextual interactions. The sensing technique is based on the precise detection and recognition of conductive objects, e.g. metallic objects, that are commonly found in households and workplaces, such as keys, coins, and electronic devices. The interactive sensing apparatus and sensing technique allow a context embedded object to be sensed by the interactive sensing apparatus when the object is in contact with the apparatus. Using this information, a desired application can thus be triggered in response to the detection of the object. In one example, a sofa can be capable of detecting if a user has left their keys on the sofa after they've left. In one example, an empty tablecloth can remind the user to set up eating utensils before guests arrive for dinner. Aside from object recognition, the sensing technique described herein can also sense the coarse movement of the contact area of the object itself, allowing a new dimension of input to be carried out through gestures.

The interactive sensing apparatus described herein can be fabric-based and demonstrate technical feasibility and new applications enabled by the corresponding sensing technique. The fabric-based interactive sensing apparatus can include a grid of six by six spiral-shaped coils made of a conductive thread, sewn onto a four-layer fabric structure. The size and shape of the coils can have a predetermined pattern to maximize the sensitivity to objects of different materials and shapes. The optimization can be performed based on a mathematical model developed to approximate coil inductance, which is a direct measure of sensor sensitivity. Experimental results are described using common objects that include a mix of conductive objects and non-conductive objects, instrumented using low-cost copper tape. Results from ten participants revealed 93.9% real-time accuracy for object recognition.

User input on interactive fabrics can be mainly performed through touch or deforming the fabric itself. The technique and apparatus described herein can be mainly divided into those using capacitance, resistance, and optics.

The class of work utilizing capacitive sensing can be largely based on fabric capacitors made of conductive materials acting as electrode plates. On a piece of fabric, the electrodes can be created using conductive threads or inks.

The approaches using resistive sensing can be based on fabric resistors. A common structure of the sensor in this category includes two conductor layers separated by a semi-conductive middle layer.

In one example, eCushion includes a middle layer made by a semi-conductive material sandwiched by a top and bottom layer made by fabric coated with parallel conductive buses. Applications for this type of sensor are wide. For example, eCushion was developed for detecting sitting postures. See Wenyao Xu, Ming-Chun Huang, Navid Amini, Lei He and Majid Sarrafzadeh. 2013. eCushion: A Textile Pressure Sensor Array Design and Calibration for Sitting Posture Analysis. IEEE Sensors Journal, 13 (10). 3926-3934. DOI—https://doi.org/10.1109/JSEN.2013.2259589, incorporated herein by reference in its entirety.

In one example, GestureSleeve is an interactive sleeve that allows a user to use touch gestures to interact with computing devices on the forearm. See Stefan Schneegass and Alexandra Voit. 2016. GestureSleeve: using touch sensitive fabrics for gestural input on the forearm for controlling smartwatches. In Proceedings of the 2016 ACM International Symposium on Wearable Computers (ISWC '16), 108-115. DOI—https://doi.org/10.1145/2971763.2971797, incorporated herein by reference in its entirety.

In one example, proCover uses a similar type of sensor to augment prosthetic limbs. See Joanne Leong, Patrick Parzer, Florian Perteneder, Teo Babic, Christian Rendl, Anita Vogl, Hubert Egger, Alex Olwal and Michael Haller. 2016. proCover: Sensory Augmentation of Prosthetic Limbs Using Smart Textile Covers. In Proceedings of the 29th Annual Symposium on User Interface Software and Technology (UIST'16), 335-346. DOI—https://doi.org/10.1145/2984511.2984572, incorporated herein by reference in its entirety.

In the space of interactive fabric, object recognition has been largely overlooked. In one example, pressure profiles (e.g., weight and shape) are utilized to distinguish objects on a piece of fabric. However, without an evaluation of object recognition on interactive fabric, it can be difficult to understand how well this technique works. The techniques described herein can determine identity based on the material of the object and is based on contact. This allows the sensor described herein to be used in scenarios where weight may not be a reliable indication of an object's identity.

Object recognition can be achieved using two approaches, with the main difference being attributed to the need for target objects to be instrumented.

The approach of relying on instrumentation requires the target objects to be tagged. Radio frequency identification (RFID) tag is an example which is used in a large number of object recognition applications. Near-Field Communication (NFC) tags are another option, which was used in research projects like Capacitive NFCs and Zanzibar. See Tobias Grosse-Puppendahl, Sebastian Herber, Raphael Wimmer, Frank Englert, Sebastian Beck, Julian von Wilmsdorff, Reiner Wichert and Arjan Kuijper. 2014. Capacitive near-field communication for ubiquitous interaction and perception. In Proceedings of the 2014 ACM International Joint Conference on Pervasive and Ubiquitous Computing (UbiComp'14), 231-242. DOI=https://doi.org/10.1145/2632048.2632053, incorporated herein by reference in its entirety. See Nicolas Villar, Daniel Cletheroe, Greg Saul, Christian Holz, Tim Regan, Oscar Salandin, Misha Sra, Hui-Shyong Yeo, William Field and Haiyan Zhang. 2018. Project Zanzibar: A Portable and Flexible Tangible Interaction Platform. In Proceedings of the 2018 CHI Conference on Human Factors in Computing Systems. DOI=https://doi.org/10.1145/3173574.3174089, incorporated herein by reference in its entirety.

In the commercial market, optical solutions like QR codes have been widely used to encode information about different products.

In one example, iCon uses the vision based approach for tangible input through daily objects using pattern stickers. Although instrumenting target objects is generally an effective approach in many application domains, the limitation is obvious as the objects must be tagged, or the technology will not work. See Kai-Yin Cheng, Rong-Hao Liang, Bing-Yu Chen, Rung-Huei Laing and Sy-Yen Kuo. 2010. iCon: utilizing everyday objects as additional, auxiliary and instant tabletop controllers. In Proceedings of the SIGCHI Conference on Human Factors in Computing Systems (CHI'10), 1155-1164. DOI=https://doi.org/10.1145/1753326.1753499, incorporated herein by reference in its entirety.

Technologies without the requirement of using tags often rely on computer vision, which requires an object to be visible and privacy can be a concern for using cameras. More recently, mechanical or electronic properties of the target objects (e.g., EM signatures, vibration patterns, etc.) are also exploited. For example, acoustics-based approaches recognize objects that can emit a sound. EM-Sense recognizes electrical objects via the electromagnetic signals emitted from the objects.

In one example, ViBand recognizes objects through patterns of different mechanical vibrations. See Gierad Laput, Robert Xiao and Chris Harrison. 2016. Viband: High-fidelity bio-acoustic sensing using commodity smartwatch accelerometers. In Proceedings of the 29th Annual Symposium on User Interface Software and Technology (UIST'16), 321-333. DOI=https://doi.org/10.1145/2984511.2984582, incorporated herein by reference in its entirety.

In one example, Radarcat uses multi-channel radar signals to recognize electrical or non-electrical objects. However, object recognition on soft fabric is overlooked. See Hui-Shyong Yeo, Gergely Flamich, Patrick Schrempf, David Harris-Birtill and Aaron Quigley. 2016. Radarcat: Radar categorization for input and interaction. In Proceedings of the 29th Annual Symposium on User Interface Software and Technology (UIST'16), 833-841. DOI=https://doi.org/10.1145/2984511.2984515, incorporated herein by reference in its entirety.

Inductive sensing has been used in many applications, including position sensing and the detection of defects in metal objects and structures.

In one example, Indutivo used inductive sensing to enable contact-based, object driven interactions for input-limited devices like smartwatches. Guidelines were provided for the design and implementation of sensors coils to achieve an optimized sensing performance. See Jun Gong, Xin Yang, Teddy Seyed, Josh Urban Davis and Xing-Dong Yang. 2018. Indutivo: Contact-Based, Object-Driven Interactions with Inductive Sensing. In Proceedings of the 31st Annual ACM Symposium on User Interface Software and Technology (UIST'18), 321-333. DOI=https://doi.org/10.1145/3242587.3242662, incorporated herein by reference in its entirety.

However, object sensing and recognition via textile-integrated devices imposes many new challenges that only exist on soft fabric. For example, as described herein, sensor coils are fabricated using conductive threads, which have very different physical and electronic properties than, for example, copper wires used on a rigid substrate. Thus, knowledge developed previously becomes inapplicable to the coil design. The methods described herein overcame these challenges.

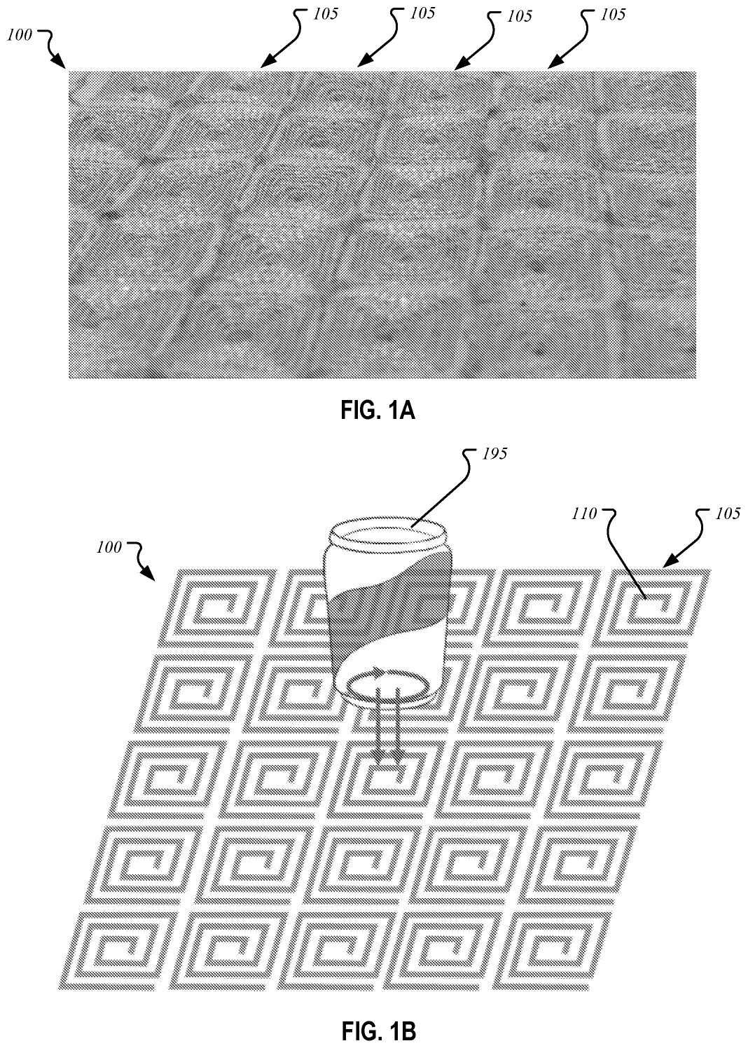

FIG. 1A is an optical image of a fabric-based interactive sensing apparatus 100 (herein referred to as “sensing apparatus 100”) that can detect conductive objects placed on it, according to an embodiment of the disclosure. In an embodiment, the sensing apparatus 100 can include a substrate formed of a textile and at least one sensor 105 including an inductive coil 110, the inductive coil 110 being formed from a conductive fiber, the inductive coil 110 being sewn into the substrate, each sensor of the at least one sensor 105 configured to detect an object proximal to the at least one sensor 105 via inductive coupling and output a signal based on a change in a resonant frequency of the at least one sensor 105.

FIG. 1B is a schematic of the sensing apparatus 100 including an object 195, according to an embodiment of the present disclosure. In an embodiment, the sensing apparatus 100 can differentiate conductive objects, such as the object 195 shown as a metallic beverage can, that are either environmental or artificial.

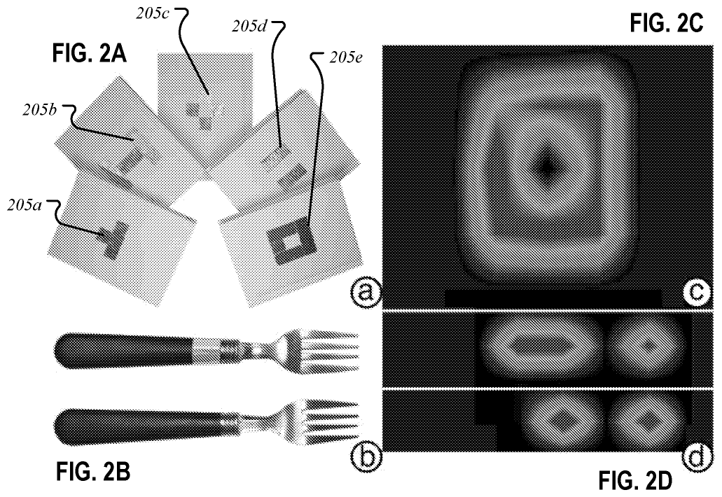

FIGS. 2A-2D show environmental and artificial conductive objects and their inductive footprints, according to an embodiment of the disclosure. Environmentally conductive objects are common in everyday life, from the smartphone to the utensils on a dinner table that sit on a table cloth (see FIGS. 2B and 2D). Artificial conductive objects are those manually instrumented using conductive markers in the object's contact area (see FIGS. 2A and 2C). Examples of manually instrumented conductive markers can include a first conductive marker 205a, a second conductive marker 205b, a third conductive marker 205c, a fourth conductive marker 205d, and a fifth conductive marker 205e. By identifying the unique pattern of the conductive markers 205a-e through respective inductance footprints, the associated object can be recognized. These unique patterns of the conductive markers 205a-e can increase the range and scope of object recognition on the sensing apparatus 100. In an embodiment, copper tape can be utilized to create the conductive markers 205a-e to instrument/tag both conductive and non-conductive objects. Unlike Indutivo, whose sensor coils were arranged in a 1D space, the sensing apparatus 100 can employ a 2D coil array including the at least one sensor 205, thus allowing the conductive markers 205a-e to be designed with even richer or more intricate 2D geometry shapes.

Inductive sensing can be used for low-cost, high-resolution sensing of electrically conductive (mostly metallic) objects. The principle of inductive sensing can be based on Faraday's law of induction, which can be described as the following: a current-carrying conductor can “induce” a current to flow in a second conductor. For example, when an alternating current (AC) is passed through a L-C resonator, comprising of an inductor (e.g., the spiral-shaped inductive coil 110 of the at least one sensor 105) and a capacitor, it results in a time-varying electromagnetic filed. When a conductive object is brought into this electromagnetic field, a circulating current known as an eddy current is induced on the surface of the conductive object. For example, see the object 195 in FIG. 1B. In turn, the induced eddy current generates its own electromagnetic field, which opposes the original magnetic field generated by the L-C resonator. Therefore, a shift of the resonant frequency of the L-C resonator can be observed, through the sensor (e.g. the at least one sensor 105), due to mutual inductance. According to formula (1), when the resonant frequency changes, the coil (e.g. the inductive coil 110) inductance changes accordingly. This forms the basis of the sensing technique:

$$\\ \begin{matrix}{f}_{0} = \frac{1}{2 π \sqrt{LC}} & ( 1 )\end{matrix}$$

where ƒ₀ is the measured resonant frequency, L is the coil inductance and C is the capacitance of the known capacitor.

The amount of the change in the resonant frequency or in turn the coil's inductance, relates to an abundance of information about the conductive object, such as its size, shape, electrical properties (e.g., resistivity) and distance. This information can be used for object recognition. A key component of inductive sensing is the design of the at least one sensor 105, which should aim to reduce the inductance of the inductive coil 110 for improved sensitivity to different objects. This is because when the inductive coil 110's inductance is small, a tiny change in its inductance caused by the object 195 can be related to a more observable shift in the measured resonant frequency.

Most conductive objects have capacitance and inductance, and both properties affect the resonant frequency. The effect of inductance dominates that of capacitance with most metallic objects. In contrast, the effect of capacitance becomes dominant with most non-metallic conductive objects, such as a finger. As a side effect, the sensing apparatus 100 can also differentiate a finger from conductive objects due to the opposing influence on measured resonant frequency from both effects.

Unlike sensor coils printed on a rigid substrate, developing inductive sensing on a textile as disclosed herein requires a different approach. In an embodiment, the sensing apparatus 100 uses conductive threads, which can be easily stitched on a fabric to spiral the inductive coil 110 in the at least one sensor 105 using common fabrication devices, such as a home embroidery sewing machine (e.g., Brother SE600). Stitching creates traces that are mechanically stable and durable. The shape patterns of the inductive coil 110 (e.g., shape and size) can be designed using graphics editing software and then saved into an embroidery file format.

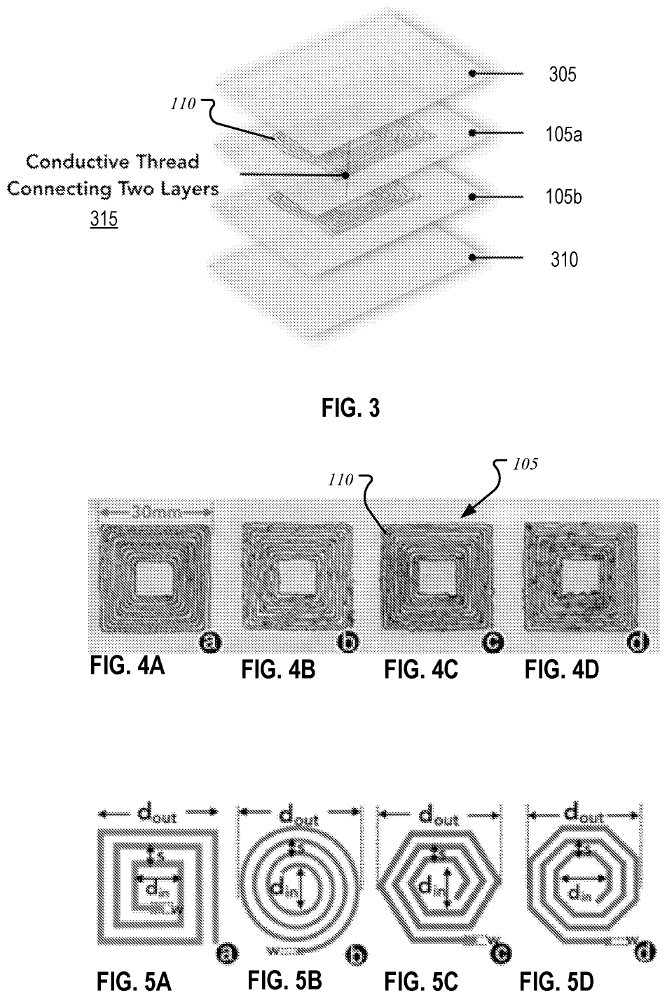

FIG. 3 shows a four-layer structure including the sensing apparatus 100, according to an embodiment of the disclosure. In an embodiment, two layers of the at least one sensor 105 are used by aligning two single layers (a first layer 105a and a second layer 105b) of the at least one sensor 105 back-to-back. However, this is not easy because the standard stitching process on a sewing machine pushes the conductive threads through the substrate, causing short circuits between the opposite-side at least one sensors 105. Thus, the tension of the top thread (e.g., non-conductive thread) can be tuned to ensure that the conductive thread on the back only floated on the surface of the substrate without penetrating it. The two layers of the at least one sensor 105 can be sewed together, with the inductive coils 110 well aligned, facing outwards. Finally, the opposite-sided at least one sensors 105 were connected. This was performed by connecting the spiral centers of the inductive coils 110 together using a twist splice 315. The connection was then fixed in place using an adhesive, such as hot glue. It may be appreciated that the connection can be fixed using the adhesive or replaced using a stitch. The first layer 105a and the second layer 105b of the at least one sensor 105 can be sandwiched between a first insulation layer 305 and a second insulation layer 310 to avoid the coils being shorted by the conductive object 195.

One of the major challenges in enabling inductive sensing on a soft fabric is the choice of the right conductive threads. First, the threads should guarantee a high conductivity, otherwise the self-resonant frequency of the inductive coil 110 may decrease to a level that intersects with the resonant frequency of the at least one sensor 105 (e.g., L-C resonator). This will cause serious jittering in the signal of the at least one sensor 105, as discussed below. Second, the conductive thread can be thin to enable using a standard home sewing device up to the level of precision needed to make the inductive coil 110. It may be appreciated that the desire for a thin thread can be eliminated by using more precise fabrication devices.

### EXAMPLES

Example 1—Amongst what is available on the market currently, 4 candidates are described (shown in Table 1), within which, all threads are made of stainless steel, except for the LIBERATOR 40, which is made of silver-plated fiber. The conductivity of these candidates ranges from 3.28 to 91.84 Ω/m (e.g., all below 100 Ω/m).

TABLE 1
Conductive Yarn Candidates.

| | | Stainless | Smooth | Conductive |
|---|---|---|---|---|
| | LIBERATOR | thin | conductive | thread |
| Name | 40 | thread | thread | bobbin |
| Manuf./ | Syscom | Adafruit | Sparkfun | Sparkfun |
| Distributor | | | | |
| Yarn Type | Single twine | Double | Triple | Double |
| | | twine | twine | twine |
| Material | Silver coated | 316L | 12UM | 316L |
| | polymer | Stainless | Stainless | Stainless |
| | | steel fiber | steel fiber | steel fiber |
| Thickness | 0.18 | 0.20 | 0.12 | 0.35 |
| (mm) | | | | |
| Conductivity | 3.28 | 51.18 | 27.00 | 91.84 |
| (Ω per m) | | | | |

FIGS. 4A-4D show tested coils including different conductive threads, according to an embodiment of the disclosure. In an embodiment, the signal stability of these different thread options was determined using a rectangular-shape for the inductive coil 110 (e.g., dₒᵤₜ=30 mm, n=10, s=0.90 mm, see parameter descriptions later) fabricated via a sewing and embroidery machine (Brother SE600). It may be appreciated that many textiles may be used as the substrate, but the substrate used in this test across all the thread options was Drill 40 Unbleached 17181 (100% cotton). The signals from the tested coils were measured using a Texas Instruments LDC1614 evaluation board for inductive sensing. Software (i.e. Sensing Solutions EVM GUI) was used alongside the evaluation board to acquire signal (e.g., sensor's inductance) of the at least one sensor 105.

The LIBERATOR 40 was conductive enough to guarantee the stability of the at least one sensor 105 signal. The highest variance observed reached up to ˜1000 uH, even without the presence of a conductive object. This was significantly higher than the normal range of 0.002 uH, observed from the inductive coils 110 made of LIBERATOR 40. As discussed earlier, the jittering is mainly due to the lack of conductivity of the inductive coils 110. Therefore, the LIBERATOR 40 was chosen for development of the sensing apparatus 100. LIBERATOR 40 has a light-weight, flexible and high-strength fiber core with a conductive metal outer layer, which is commonly used as shielding braid, bare wire, or is coated with insulation material.

The present disclosure discusses (in several dimensions) how the design of inductive coils 110 can be optimized around coil inductance in the context of the sensing apparatus 100.

Example 2—As previously mentioned, the present disclosure aims to reduce inductance of the inductive coil 110 to improve the sensitivity of the at least one sensor 105 to different objects. The minimum coil inductance is bound by the working range of the inductance-to-digital converter. For example, the LDC1614 chip has a lower bound at around 1.49 uH with suggested 680 pF capacitor (or 5 MHz in resonant frequency), below which sensor signals become unstable. Therefore, the most suitable design for the inductive coil 110 of the sensing apparatus 100 is one that has a coil inductance of around 1.49 uH, but not smaller.

Aside from coil inductance, the present disclosure describes a constraint in the size of the inductive coil 110 as a small and dense grid of inductive coils 110 enables a greater sensing resolution in a 2D space, for both detecting object movements on the [fabric] surface of the sensing apparatus 100, as well as sensing the shape of the object's contact area, which is useful for gestural input using a conductive object. Therefore, a goal of the present disclosure was to design the inductive coil 110 to be the smallest in size without violating the inductance requirement.

The size of the inductive coil 110 can be further reduced without decreasing coil inductance using a multi-layer design (e.g., 2, 4, 6 layers). Therefore, in the present disclosure, a two-layer design was used. Although more layers are possible, two layers avoided making the fabric too thick. Finally, optimizing the other parameters can help further minimize the inductive coil 110 size without reducing coil inductance.

FIGS. 5A-5D show designs of the spiral inductive coil 110, according to an embodiment of the disclosure. In an embodiment, the inductive coil 110 can be made into any shape, but the most common ones can include square, hexagon, octagon, and circle. The shape of the inductive coil 110 mainly affects sensing distance and sensing area. The circular shape has the best quality factor and lowest series resistance, thus allowing the largest possible sensing distance among the four options. Alternatively, a rectangular shape has the largest sensing area per inductive coil 110 unit in a 2D space. Sensing distance was kept small to avoid false positives while the sensing area should be kept large to maximize sensing region. The present disclosure thus used the rectangular shape for the inductive coil 110 of the at least one sensor 105.

Once the shape is determined, the shape parameters can be optimized to achieve the desired inductance.

For a given shape, the inductive coil 110 can completely be specified by the number of turns (n), width of trace (w), trace spacing (s), and any one of the following: the outer diameter dₒᵤₜ, the inner diameter dᵢₙ, the average diameter, defined as d_{avg}=(dₒᵤₜ+dᵢₙ)/2, and the fill ratio, defined as ρ=(dₒᵤₜ−dᵢₙ)/=(dₒᵤₜ+dᵢₙ).

If the value of each shape parameter is determined, the coil inductance can be calculated in theory using a sheet approximation formula. However, the challenge here was that this formula was designed for coils made from copper. Therefore, the present disclosure constructed a new formula. Curve fitting can be used.

For the single-layer design, the monomial fitted inductance equation proposed by Mohan et al. was used:

L_{single}=βdₒᵤₜ^{α}^{₁}w^{α}^{₂}d_{avg}^{α}^{₃}n^{α}^{₄}s^{α}^{₅} (2)

where L single is the inductance of the inductive coil 110 of a certain design, which can be measured using an LCR Meter; w is a constant value indicating the width of the conductive thread (e.g., 0.18 mm for LIBERATOR 40); β and α₁ are unknown coefficients specific to the LIBERATOR 40 thread. Their values were determined by identifying the best fit to the measured inductance values of a set of known coil designs. See Sunderarajan S Mohan, Maria del Mar Hershenson, Stephen P Boyd and Thomas H Lee. 1999. Simple accurate expressions for planar spiral inductances. IEEE Journal of solid-state circuits, 34 (10). 1419-1424. DOI=https://doi.org/10.1109/4.792620, incorporated herein by reference in its entirety.

To capture data for curve fitting, five different values for dₒᵤₜ were used, ranging from 10 mm to 30 mm, with a constant interval of 5 mm. Five different values for spacing s were used, ranging from 0.54 mm (3×w) to 0.90 mm (5×w), with an interval of 0.09 mm (0.5×w). Note that the typical spiral coils are built with s≤w to maximize the interwinding magnetic coupling. However, this can be hard to achieve on a fabric using stitching. Therefore, s can start from 0.54 mm (3×w) in the present disclosure.

The present disclosure iterated all possible numbers of turns (n) that could lead to the coil designs satisfying the requirements of 0.1≤dᵢₙ/dₒᵤₜ≤0.9. Note that the relationship between number of turns (n) and dᵢₙ can be determined using the following formula:

dᵢₙ=dₒᵤₜ−2(n−1)(w+s)−2w (3)

In total, the present disclosure derived 229 different designs for the inductive coil 110 for data fitting, each representing a dₒᵤₜ×s×n combination. The inductive coil 110 were sewn on the Drill 40 substrate using the Brother sewing machine. The inductance (L_{single}) of each design was measured manually using a DE-5000 Handheld LCR Meter.

A logarithmic transformation was used on both sides of the equation (4), before a least squares fitting was used to fit the data. The resulting approximation formula is:

L_{single}=0.001·dₒᵤₜ^{-0.7}d_{avg}²n^{1.7}s^{-0.2} (4)

The R-squared and root-mean-square error for this model is 0.995 and 0.088 respectively, indicating that the model fits the testing data well.

In a multi-layer design, the total inductance (Lₜₒₜₐₗ) of the inductive coils 110 in series (e.g., the two opposite-side coils), can be calculated using formula (5).

$$\\ \begin{matrix}{L}_{total} = {\sum }_{i = 1}^{N} {L}_{i} + 2 \cdot ( {\sum }_{j = 1}^{N - 1} {\sum }_{m = j + 1}^{N} {M}_{j , m} ) & ( 5 )\end{matrix}$$

where N is the number of layers (2 in this case). M_{j,m} is the mutual inductance between the inductive coils 110, which is defined as k·\sqrt{Lⱼ·Lₘ}, in which, Lⱼ and Lₘ are the inductance of layer j and m, which can be calculated using equation (4). The parameter k is the measure of the flux linkage between the inductive coils 110, whose value varies between 0 and 1. k is only related to number of turns (n) and a relative constant thickness of the fabric substrate (e.g., 1mm in the case of two Drill 40 substrates). Thus, k can be described using the following formula:

$$\\ \begin{matrix}k = γ \cdot \frac{{n}^{2}}{0.64 * ( 1.67 {n}^{2} - 5.84 n + 65 )} & ( 6 )\end{matrix}$$

where γ is the unknown coefficient, which could also be found using a least squares fitting. Within the 229 coil designs used to find the equation for the single-layer inductive coils 110, and for each possible n (e.g., from 2 to 19), the largest, smallest and medium inductances were chosen, which were then stitched into two Drill 40 substrates and sewn together. The inductance Lₜₒₜₐₗ of each design was measured manually using a DE-5000 Handheld LCR Meter. After fitting, the resulting approximation formula for a two-layer design is shown in Formula (7) with:

$$\\ \begin{matrix}{L}_{total} = {L}_{1} + {L}_{2} + \frac{2.27 {n}^{2}}{0.64 * ( 1.67 {n}^{2} - 5.84 n + 65 )} \cdot \sqrt{{L}_{1} {L}_{2}} & ( 7 )\end{matrix}$$

The R-squared and root-mean-square error for this model is 0.992 and 0.49 respectively, indicating that the model fits the testing data well. This model was used to guide the optimization of the final designs for the inductive coil 110.

With formula (7), a goal of the present disclosure was to traverse all 7165 possible design solutions, calculate the theoretical inductance value for each candidate, and narrow down the search by identifying the smallest inductive coils 110 with an inductance of around 1.49uH. Table 2 shows the results, including one preferred design.

TABLE 2
Coil designs that met predetermined criteria.
The one highlighted in the first row was chosen.

| Outer | Trace | | Approx. | Real | Real |
|---|---|---|---|---|---|
| Dia- | Spac- | | Induc- | Induc- | Resonant |
| meter | ing | | tance | tance | Frequency |
| (mm) | (mm) | Turns | (uH) | (uH) | (MHz) |
| 13 | 0.54 | 8 | 1.605 | 1.507 | 4.972 |
| 13 | 0.55 | 8 | 1.572 | 1.475 | 5.025 |
| 13 | 0.56 | 8 | 1.539 | 1.428 | 5.107 |

All candidates in Table 2 were implemented by stitching them on the Drill 40 substrate. The inductance values of the designs were measured using the LCR meter. The results revealed that the inductance of all the candidates in the shortlist were around 1.49 uH, but only one had a value higher than 1.49 uH, which satisfied the aforementioned requirements. This suggests that the design described herein is most effective.

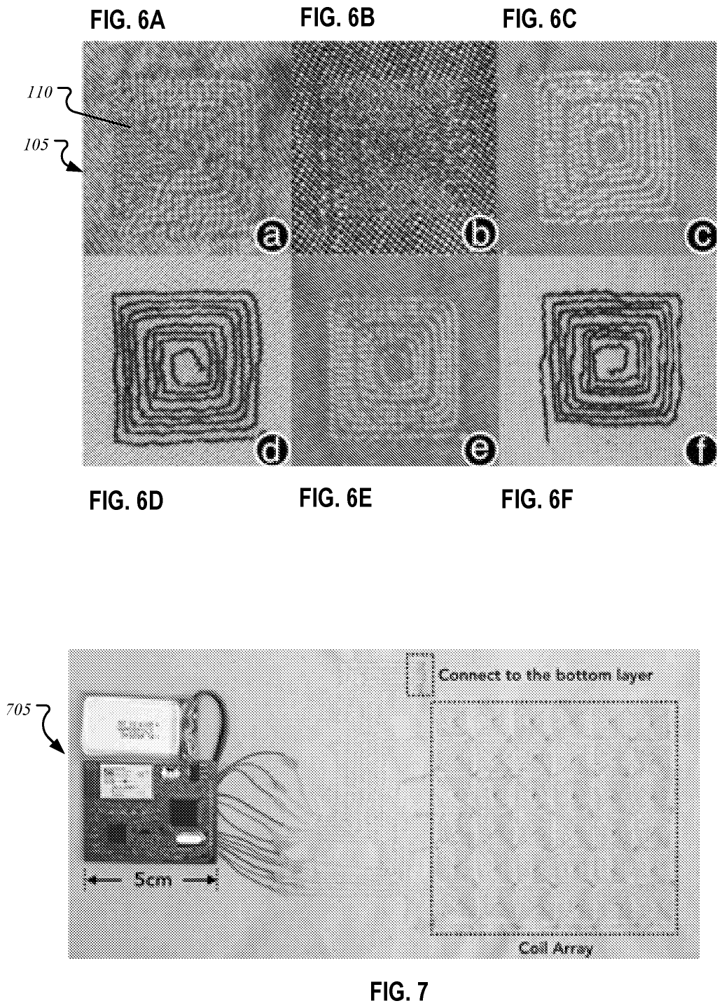

FIGS. 6A-6F show the inductive coil 110 on different types of substrates, according to an embodiment of the disclosure. A preliminary evaluation to understand if the material of the fabric substrates has an effect on the inductive coil 110's inductance was performed. Since the effect of the thickness of the substrates is known, this experiment only focused on the material. Thus, a single-layer version of the at least one sensor 105 was used. Among the numerous options available in the market, six representatives were chosen made from polyester, lyocell, nylon, modal rayon, Bemberg rayon, and cotton, as they are commonly used in garments, toys and furniture (Table 3).

TABLE 3
Different types of substrates tested.

| | Lp Satin | Dark | | White | Black | Drill 40 |
|---|---|---|---|---|---|---|
| | Solid Black | Wash | Ripstop | Modal | Ambience | Unbleached |
| Name | 17120 | 17330 | 18189 | 16360 | 18081 | 17181 |
| Manuf. | Glitterbug | DENIM | Utility | DENIM | Lining | Utility |
| | | | Fabric | | | Fabric |
| Material | 100% | 100% | 100% | 100% | 100% | 100% |
| | Polyester | Lyocell | Nylon | Modal | Bemberg | Cotton |
| | | | | Rayon | Rayon | |
| Average | 0.478 | 0.479 | 0.455 | 0.473 | 0.456 | 0.460 |
| Inductance | (s.e. = | (s.e. = | (s.e. = | (s.e. = | (s.e. = | (s.e. = |
| (uH) | 0.009) | 0.022) | 0.024) | 0.020) | 0.016) | 0.006) |

Example 3—The final inductive coil 110 design was used in single layer and five coils were stitched on each tested substrate. The inductance of the 25 varying at least one sensors 105 was measured using the LDC1614 evaluation board. There was no observable difference between the average sensor data obtained from the five substrates, which suggested that substrate material had a negligible effect on signal of the at least one sensor 105 (Table 3). In the present disclosure, the Drill 40 Unbleached 17181 (100% cotton) was chosen due to the wide adoption of cotton in fabric materials and relatively small variance.

FIG. 7 shows the sensing apparatus 100 with a sensing board to form a sensing system (herein referred to as “system”), according to an embodiment of the disclosure. In an embodiment, the sensing apparatus 100 includes a customized sensing board 705 using a Cortex M4 micro-controller (MK20DX256VLH7) powered by Teensy 3.2 firmware. The sensing board 705 has four 4:1 multiplexers (FSUSB74, ON Semiconductor), an inductive sensing chip (LDC1614, Texas Instruments), a power management circuit, and a Bluetooth module (RN42, Microchip Technology). The sensing board 705 can drive, for example, 8×8 coils. Two multiplexers were used to control the columns of the at least one sensors 105 and another two to control the rows. The sensing apparatus 100 includes a 6×6 grid layout of the at least one sensor 105.

Note that a multiplexer with more input channels (e.g., 8:1 or 16:1) was not used. This is because there is a side effect of having extra input channels—increased on-resistance (Rₒₙ) and on-capacitance (Cₒₙ), which may cause serious jittering in the at least one sensor 105's signal. An initial test suggested that in order for the LDC1614 to work properly, Rₒₙ and Cₒₙ should be less than 10Ω and 10 pF respectively. Among what is available commercially, few products satisfy this requirement. Thus, a 4:1 multiplexer was used instead. Rₒₙ and Cₒₙ of our multiplexers is 6.5Ω and 7.5 pF, respectively.

The system has a sampling rate of around 300 Hz. All sensor readings were sent to a laptop for data processing via Bluetooth. In total, the entire system consumes 250.5 mW of power, including those consumed by the Bluetooth radio (99 mW). With a 650 mAh lithium-polymer battery, the system can work for at least 2 hours.

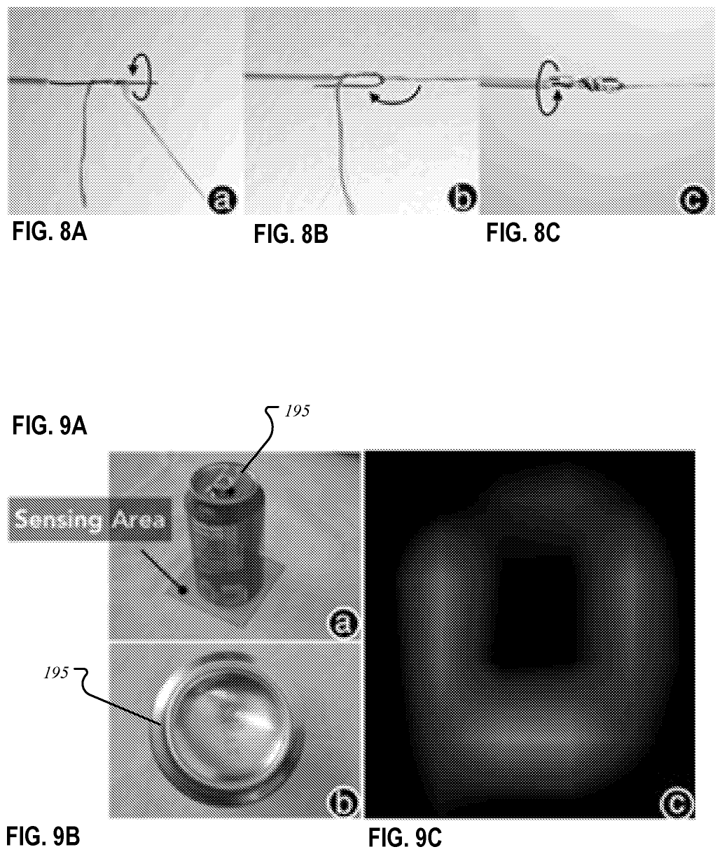

FIGS. 8A-8C show a splice used to connect a conductive thread to a wire, according to an embodiment of the disclosure. The next challenge was to connect the coils to the sensing board 705. Connecting the conductive threads to rigid electronics is currently an open problem yet to be solved. A number of methods were used, including using snap buttons, sewing, conductive epoxy, crimping and so on. In the case of LIBERATOR 40, the thread can be soldered directly under a certain temperature by following its datasheet. However, the present disclosure found that solder heat made the tip of the thread (at its connection) extremely fragile, causing unreliable wire connections across the sensor grid. In an embodiment, after iterating upon a number of different methods, such as snap buttons, a splice as shown in FIG. 8 was used. It was robust against stretching and folding. Once all the threads were connected to the electric wires, the connections needed to be fixed in place. An adhesive was used, but it may be appreciated that other materials can be used to secure the connections. Although a bit bulky in its current form, this type of connection was stable, durable, and performed well.

The sensing apparatus 100 recognizes a conductive object by comparing its inductance footprint with a machine learning model trained using a pre-collected database of labeled references. A classification pipeline is described herein.

FIGS. 9A-9C show the object 195 and a heatmap of an inductance footprint of the object 196, according to an embodiment of the disclosure. In an embodiment, when the conductive object 195 is placed anywhere inside the sensing apparatus 100, the sensing apparatus 100 reports a 6×6 array of inductance values, one from each sensor of the at least one sensor 105. This data can include the 2D inductance footprint of the object 195, describing object material (e.g., resistivity) and low-resolution geometry information of the object 195's contact area.

Before object recognition is performed, the raw sensor data from each sensor of the at least one sensor 105 was smoothed using a low pass filter to reduce the fluctuations in sensor readings. The data was then mapped to a value from 0 to 255 using the peak value observed from each sensor of the at least one sensor 105. Finally, the sensor data was upscaled from 6×6 pixels to a 100×100 heat map image using linear interpolation. FIG. 9 demonstrates an example of the object 195 as a beverage can and the corresponding inductance footprint shown in a heat map image.

The present disclosure uses machine learning for object recognition. There are many options for classification algorithms (e.g., Hidden Markov Models and Convolutional Neural Networks). In the present disclosure, Random Forest was used because it has been found to be accurate, robust, scalable, and efficient in applications involving small devices.

Object recognition using inductive sensing is primarily based on two types of information, the material and 2D geometry of the contact area of the objects. The present disclosure derived 81 features, shown in Table 4. Features were selected that are invariant to the location and orientation of the contact area of the object.

With the presence of a finger, the inductance readings measured by the sensing apparatus 100 increases slightly instead of decreasing due to the capacitance effect discussed before. Thus, a simple heuristic was used to identify the finger by checking whether readings in the sensing apparatus 100 surpass a threshold chosen by a pre-test.

TABLE 4
The feature set extracted to train machine learning model.

| | |
|---|---|
| Shape- | Local Binary Pattern (36) |
| Related | Hu Moments (7) |
| Features | Object Area (1): Number of pixels the object covers |
| (49 | Object Edge (1): Number of pixels the object's edge covers |
| features) | Average Distance (4): Average distance from object's pixels |
| | to object's center of gravity and geometric center (2), Average |
| | distance from object's edge pixels to object's center of |
| | gravity and geometric center (2) |
| Material- | Statistical Functions (11): Mean, Variance, Max, Local |
| Related | Maximum Numbers, Median, Quantiles (3), Count above/ |
| Features | below mean, Absolute Energy of the object's pixel values |
| (32 | Entropy (1): Binned Entropy |
| features) | Ten-Fold Stats (20): Sort and divide the object's pixel values |
| | into 10 folds and average for each fold (10), Divide grayscale |
| | values (e.g., 0~255) into ten intervals and count the number |
| | of the pixels in each interval (10) |

Example 4—The performance of the sensing apparatus 100 was evaluated. The goal was to validate the object recognition accuracy of the sensing apparatus 100. Sensor robustness was also evaluated against individual variance among different users.

10 right-handed participants (average age: 23, 8 males, 2 females) were recruited to participate in this study.

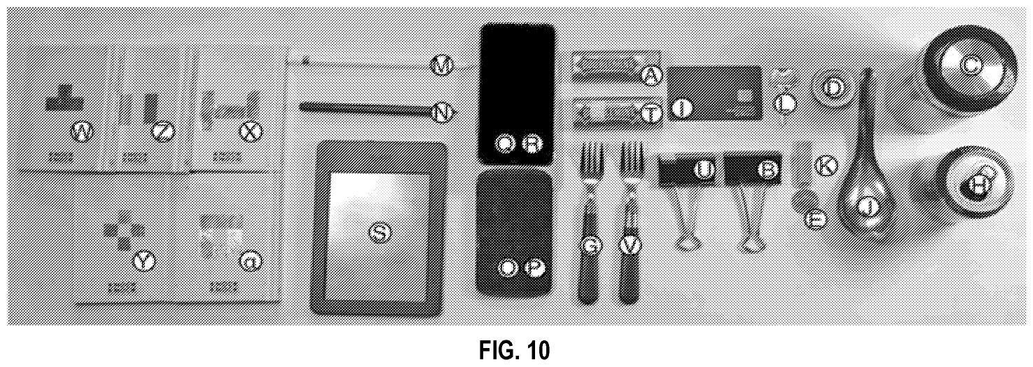

FIG. 10 shows objects tested, according to an embodiment of the disclosure. In an embodiment, the present disclosure included using 27 common conductive objects in households and workplaces to encompass a broad range of different properties (e.g., size, material, shape). The objects can be classified into four types: large or small objects and instrumented conductive or instrumented non-conductive objects. Large objects had a contact area greater than the active sensing region of the sensing apparatus 100 (e.g., the 6×6 grid). Some of the objects were metallic, while others were electronic devices with built-in metallic components. Small objects had a contact area smaller than the active sensing region. Instrumented conductive objects are those with a contact area instrumented using copper tape of 13 mm wide (e.g. the conductive markers 205a-e). Instrumented non-conductive objects are non-conductive objects with the contact areas instrumented using copper tape with different patterns.

Three days prior to the study, training data was collected by a volunteer with the sensing apparatus 100 that was powered by a wall outlet (earth ground). The sensing apparatus 100 was put on a rigid table and a volunteer was asked to place an object on the sensing apparatus 100 in random orientations and locations inside the sensing area. The only instruction the volunteer was given was to ensure the object's contact area to be exposed to the sensing apparatus 100 as much as possible. Sample data was collected 30 times per object. This volunteer was excluded from the final study.

Prior to the start of the final study, the tested objects were shown to the participants and they also understood that the object's contact area needed to be exposed to the sensing apparatus 100 as much as possible. No other instruction or practice trial was given. Unlike putting the sensing apparatus 100 on a rigid table in the training phase, participants were asked to place the tested objects on the seat of a sofa, instrumented with the sensing apparatus 100. This procedure was designed to evaluate how the collected object model worked in a more realistic setting, as daily objects that are made or covered by fabrics are commonly soft (e.g., sofa, clothing, toys). Overall, an accuracy of 93.9% (s.e.=0.69%) was achieved by the sensing apparatus 100.

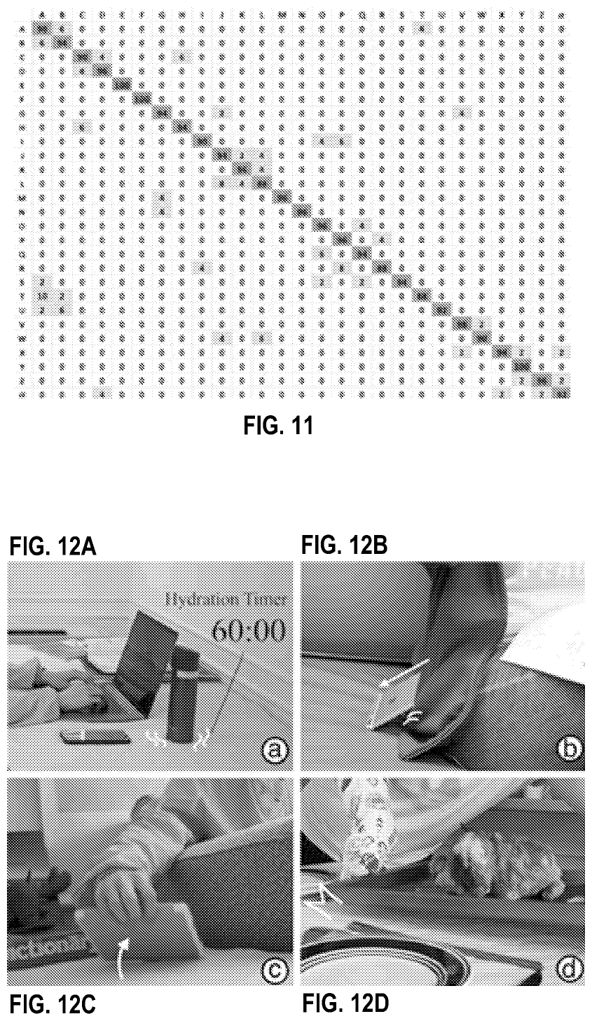

FIG. 11 shows object confusion matrices, according to an embodiment of the present disclosure. In an embodiment, among the 27 tested objects, 24 objects achieved an accuracy higher than 90%. This is a promising result, as typical experimental procedures that impact recognition accuracy were introduced—e.g., no user training, no per-user calibration, large time gap between training data collection and the study itself. The confusion matrix revealed that the candy box was occasionally misclassified as a 5 cm binder clip. This occurs when two objects are of a similar material (e.g., steel) are compared. This is further emphasized, when the contact area appears similar under the resolution of our current grid implementations.

The sensing apparatus 100 could classify an Apple Pen and a Surface Pen with a high accuracy (e.g., 98%), as these two objects share very similar contact areas but different in the electronics. It shows that the sensing apparatus 100 could effectively distinguish objects with a similar shape but made of different materials. The instrumented non-conductive objects were not significantly confused with each other, indicating that the sensing apparatus 100 could separate them only using the conductive patterns. Keys achieved the lowest accuracy (e.g., 86%) among all objects, as it was primarily confused with the spoon and USB drive. For some of these objects with a small contact area, the sensing apparatus 100 could not reliably identify them because their inductance footprints appeared to be similar to each other again due to the relatively low resolution of our coil grid. The back of an iPhone X was also confused with the back of a Nexus 4. This is because both objects have a similar inner structure with electronics and PCBs.

FIGS. 12A-12D show example applications, according to an embodiment of the present disclosure. Four application examples are presented: (1) on a tablecloth (twice), (2) in a pocket and (3) in a backpack, to showcase possibilities and demonstrate the sensing apparatus' sensing capabilities.

In one embodiment, a first application is a hydration tracker, which reminds a user of their daily water consumption when they are working at a desk. Placing a stainless mug (which we use to track) on a tablecloth starts a timer and a reminder is sent to the user's phone if the mug stays at the desk longer than a pre-set time period (FIG. 12A).

In one embodiment, a second application relies on a pocket that is instrumented with the sensing apparatus. The pocket is capable of detecting if a user's phone has slipped out of the pocket when they have gotten up and left from a sofa (FIG. 12B).

In one embodiment, a third application combines the tablecloth and a backpack to provide unobtrusive contextual sensing. For example, when a user wants to read an ebook, they grab a kindle from a table, which causes the nearby floor lamp to switch on. After the user finishes reading and puts the kindle into their backpack, the lamp turns off automatically (FIG. 12C).

In one embodiment, a fourth application is also based on a tablecloth in a dining room. A family meal has been prepared by a mother and father, whom have finished cooking and are preparing the table. As they prepare the table, their children whom are on the second floor receive a message asking them to go downstairs and enjoy the meal (FIG. 12d).

The present disclosure's coil inductance estimation formula was derived based on LIBERATOR 40 with the goal of demonstrating the feasibility of inductive sensing on a soft fabric. Further investigation is currently underway to evaluate how well the derived formulas perform with other types of conductive threads. The procedure in the design and implementation of the present disclosure being the contribution that can be generalized beyond the present work and can provide useful guidance for future research in related fields.

The present disclosure optimized the coil based on size and sensitivity. Preserving the softness of the fabric substrate can be one important consideration in future explorations. With current embodiments described above, the threads are spiraled tightly inside a small area of the at least one sensor 105, which has made the substrate harder than it was before instrumentation. There is a tradeoff between the size of the inductive coil 110 and how well the softness of fabric substrate can be preserved. A larger inductive coil 110 with the threads loosely spiraled inside it may lead to an increase in softness but sensing resolution may decrease.

Sensor readings can be affected if the coil is deformed, which may consequently introduce false detections. A study of the sensing apparatus 100 revealed no significant effect of deformation in recognizing the tested objects.

It can be challenging to detect objects that don't have a planar contact surface, as inductance values may change as the contact area changes. However, this challenge can be overcome with additional training data since the change in the inductance is consistent with respect to how the object's contact area may change.

To sense non-conductive objects, a hybrid approach can integrate inductive sensing with the other types of sensing techniques, such as those based on pressure. Some of the conductive objects might be containers (e.g., travel mug) and sensing can include differentiating content within the container (e.g., water or soda).

The present disclosure uses a simple heuristic to identify a finger, which may introduce false positives in real world settings. However, a machine learning based model can further improve the robustness.

In summary, a contact-based inductive sensing approach on interactive fabrics to recognize daily conductive objects was described. The sensing principle was discussed and an investigation on different conductive threads and substrates. The sensing apparatus 100 includes a six by six coil array, which was carefully designed to maximize the sensitivity to conductive objects based on an approximate inductance formula derived for conductive thread. Of course, other sizes and dimensions for the sensing apparatus 100 can be contemplated. Through a ten-participant user study, a 93.9% real-time classification accuracy was demonstrated with 27 daily objects that included both conductive and non-conductive objects instrumented using low-cost copper tape. A sensing methodology for object recognition on interactive fabrics was also presented to work in tandem with the sensing apparatus 100.

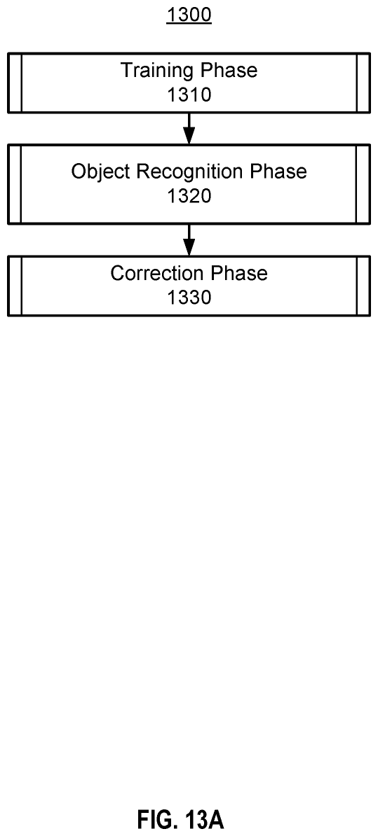

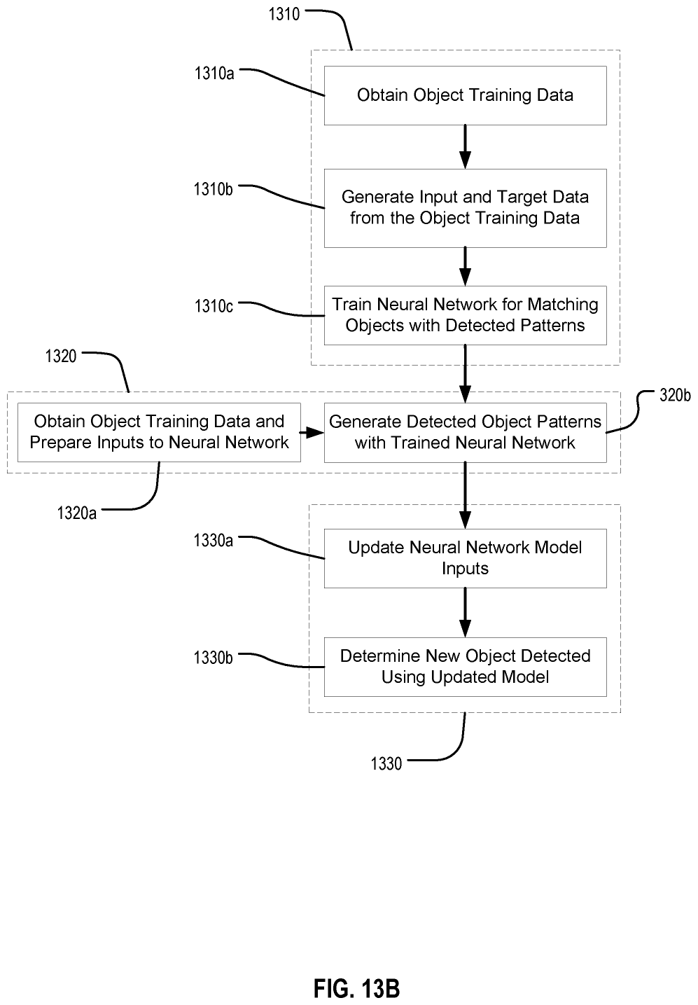

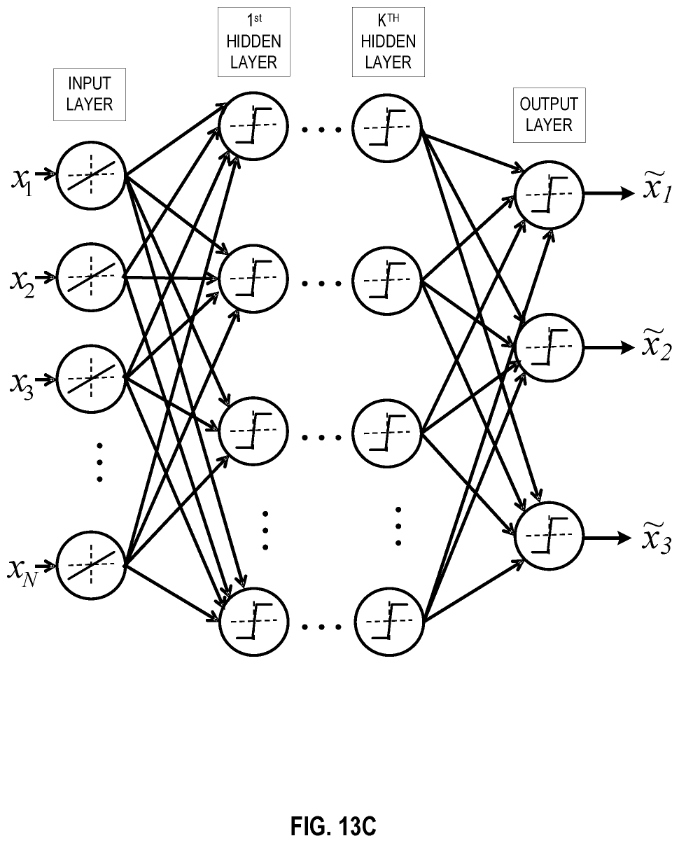

FIG. 13A provides a high-level framework for training a neural network for object recognition, according to an embodiment of the present disclosure. The neural network can be trained using a training dataset generated from ground truth object identities. In a training phase, at process 1310, training data can be generated using ground truth object identities, and the ground truth object identities can be generated from, for example, experimental results. This training data can then be used to train the neural network. In an object recognition phase, at process 1320, detected object data can be processed and then applied to the trained neural network with the result from the neural network being the updated object identity. Subsequently, in a correction phase at step 1330 of process 1300, correction of the system including the sensing apparatus 100 can be performed to reduce or remove the object recognition errors.

FIG. 13B provides a low-level flow diagram for the object recognition process, according to an embodiment of the present disclosure.

In step 1310a of process 1310, object training data can be obtained. A large object recognition training database, which includes, for example, a plurality of objects detected and respective identities, can be used to account for the several factors upon which image recognition can depend, including: size, shape, inductance characteristics, etc. To this end and according to an embodiment, the training database can include a plurality of object identities from experimental results, a look-up table, an online database, etc.

In step 1310b of process 1310, the inputs and target data for training the neural network are generated from the training data. To train the neural network, the training data includes input data paired with target data, such that when the neural network is trained applying the input data to the neural network, the neural network generates a result that matches the target data as closely as possible. To this end, the input data to the neural network can be objects with known identities based on the registered object size, shape, inductance characteristics, etc. Further, the target data of the neural network are confirmed object identities.

In step 1310c of process 1310, the training data, including the target object identities, can be used for training and optimization of the neural network. Generally, training of the neural network can proceed according to techniques understood by one of ordinary skill in the art, and the training of the neural network is not limited to the specific examples provided herein, which are provide as non-limiting examples to illustrate some ways in which the training can be performed.

Following training of the neural network in the training phase of process 1310, an object recognition phase of process 1320 can be performed.

In step 1320a of process 1320, object training data can be obtained and prepared for application to the trained neural network. The process of object training data can include any one or more of the methods described above for preparing the input images/data of the training data, or any other methods.

In step 1320b of process 1320, the prepared object training data can be applied to the trained neural network and detected object patterns can be generated. The output from the trained neural network can be used to identify or correct misidentifications of objects.

In step 1330a of process 1330, the detected object patterns output from the trained neural network and the resulting updated object detection (e.g. the model) can be used to correct the system including the sensing apparatus 100 and subsequent image detection and recognition events.

In step 1330b of process 1330, updated object detection model can be used to detect and obtain a new object identity using the system including the sensing apparatus 100.

FIG. 13C shows an example of a general artificial neural network (ANN) having N inputs, K hidden layers, and three outputs. Each layer is made up of nodes (also called neurons), and each node performs a weighted sum of the inputs and compares the result of the weighted sum to a threshold to generate an output. ANNs make up a class of functions for which the members of the class are obtained by varying thresholds, connection weights, or specifics of the architecture such as the number of nodes and/or their connectivity. The nodes in an ANN can be referred to as neurons (or as neuronal nodes), and the neurons can have inter-connections between the different layers of the ANN system. The simplest ANN has three layers and is called an autoencoder. The neural network can have more than three layers of neurons and have as many output neurons [symbol] as input neurons, wherein N is the number of pixels in the training image. The synapses (i.e., the connections between neurons) store values called “weights” (also interchangeably referred to as “coefficients” or “weighting coefficients”) that manipulate the data in the calculations. The outputs of the ANN depend on three types of parameters: (i) the interconnection pattern between the different layers of neurons, (ii) the learning process for updating the weights of the interconnections, and (iii) the activation function that converts a neuron's weighted input to its output activation.

Mathematically, a neuron's network function m(x) is defined as a composition of other functions nᵢ(x), which can be further defined as a composition of other functions. This can be conveniently represented as a network structure, with arrows depicting the dependencies between variables, as shown in FIG. 13C. For example, the ANN can use a nonlinear weighted sum, wherein m(x)=K(Σᵢwᵢnᵢ(x)) and where K (commonly referred to as the activation function) is some predefined function, such as the hyperbolic tangent.

In FIG. 13C, the neurons (i.e., nodes) are depicted by circles around a threshold function. For the non-limiting example shown in FIG. 13C, the inputs are depicted as circles around a linear function and the arrows indicate directed communications between neurons.

The neural network of the present disclosure operates to achieve a specific task, such as detecting and recognizing objects sensed by the sensing apparatus 100, by searching within the class of functions F to learn, using a set of observations, to find m*∈F, which solves the specific task in some optimal sense. For example, in certain implementations, this can be achieved by defining a cost function C:F→m such that, for the optimal solution m*, C (m*)≤C(m)∀m∈F (i.e., no solution has a cost less than the cost of the optimal solution). The cost function C is a measure of how far away a particular solution is from an optimal solution to the problem to be solved (e.g., the error). Learning algorithms iteratively search through the solution space to find a function that has the smallest possible cost. In certain implementations, the cost is minimized over a sample of the data (i.e., the training data).

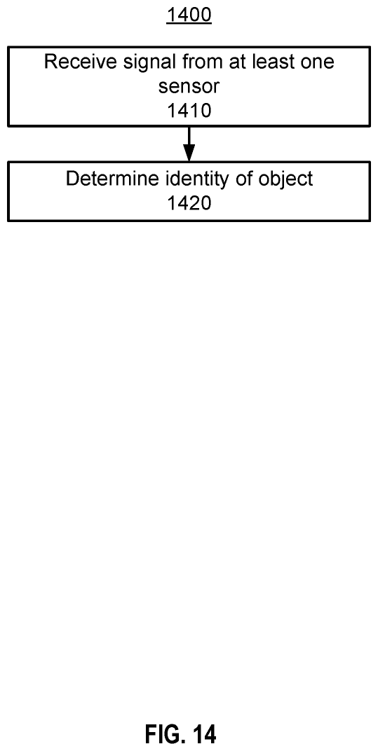

FIG. 14 shows a non-limiting example of a flow chart for a method 400 of determining object identity, according to an embodiment of the present disclosure. In step 410, a signal from the at least one sensor 105 is received, the at least one sensor 105 including the inductive coil 110, the inductive coil including a conductive fiber, the inductive coil 110 being sewn into the substrate formed of a textile, each of the at least one sensor 105 configured to detect the object 195 proximal to the at least one sensor 105 via inductive coupling and output a signal based on a change in a resonant frequency of the at least one sensor 105. In step 420, an identity of the object is determined based on the received signal.

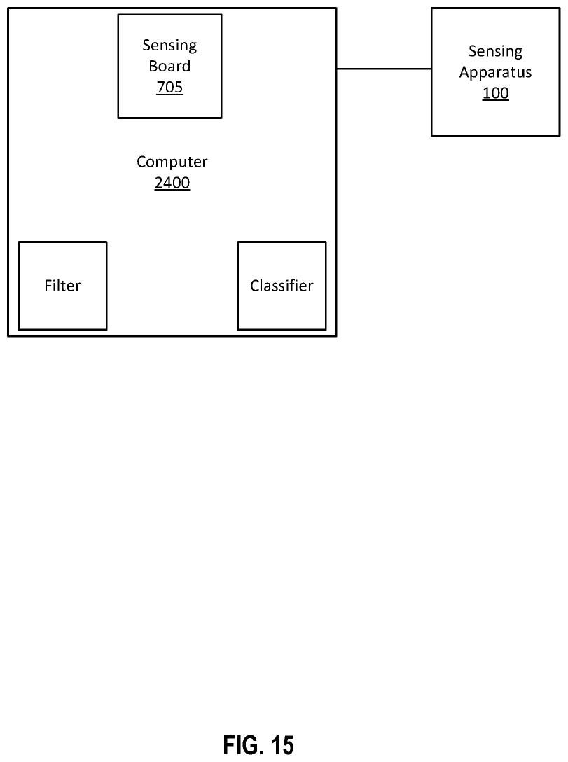

FIG. 15 is a block diagram of the sensing system including the sensing apparatus 100 used in exemplary embodiments. In an embodiment, the system includes a computer 2400 electrically connected to the sensing apparatus 100. Notably, the computer 2400 can include the customized sensing board 705 as described previously. A neural network or other classifier can be implemented on the computer 2400 and the computer 2400 can include instructions to perform application of the neural network, including filtering the raw sensor data and the classifying of the object. The computer 2400 is configured to apply the neural network to the incoming sensor data received.

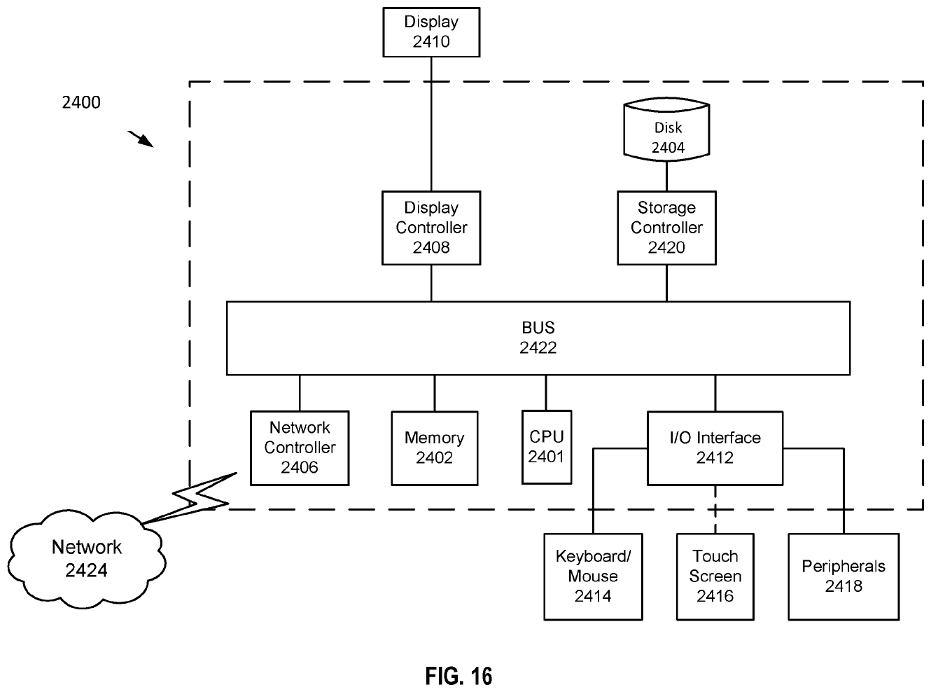

FIG. 16 is a block diagram of a hardware description of a computer 2400 used in exemplary embodiments. In the embodiments, computer 2400 can be a desk top, laptop, or server. Computer 2400 could be used as the server 130 or one or more of the client devices 140 illustrated in FIG. 1B.

In FIG. 16, the computer 2400 includes a CPU 2401 which performs the processes described herein. The process data and instructions may be stored in memory 2402. These processes and instructions may also be stored on a storage medium disk 2404 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computer 2400 communicates, such as a server or computer.

Further, the claimed advancements may be provided as a utility application, background daemon, or component of an operating system, or combination thereof, executing in conjunction with CPU 2401 and an operating system such as Microsoft® Windows®, UNIX®, Oracle® Solaris, LINUX®, Apple macOS® and other systems known to those skilled in the art.

In order to achieve the computer 2400, the hardware elements may be realized by various circuitry elements, known to those skilled in the art. For example, CPU 2401 may be a Xenon® or Core® processor from Intel Corporation of America or an Opteron® processor from AMD of America, or may be other processor types that would be recognized by one of ordinary skill in the art. Alternatively, the CPU 2401 may be implemented on an FPGA, ASIC, PLD or using discrete logic circuits, as one of ordinary skill in the art would recognize. Further, CPU 2401 may be implemented as multiple processors cooperatively working in parallel to perform the instructions of the inventive processes described above.

The computer 2400 in FIG. 16 also includes a network controller 2406, such as an Intel Ethernet PRO network interface card from Intel Corporation of America, for interfacing with network 2424. As can be appreciated, the network 2424 can be a public network, such as the Internet, or a private network such as LAN or WAN network, or any combination thereof and can also include PSTN or ISDN sub-networks. The network 2424 can also be wired, such as an Ethernet network, or can be wireless such as a cellular network including EDGE, 3G and 4G wireless cellular systems. The wireless network can also be WiFi®, Bluetooth®, or any other wireless form of communication that is known.

The computer 2400 further includes a display controller 2408, such as a NVIDIA® GeForce® GTX or Quadro® graphics adaptor from NVIDIA Corporation of America for interfacing with display 2410, such as a Hewlett Packard® HPL2445w LCD monitor. A general purpose I/O interface 2412 interfaces with a keyboard and/or mouse 2414 as well as an optional touch screen panel 2416 on or separate from display 2410. General purpose I/O interface 2412 also connects to a variety of peripherals 2418 including printers and scanners, such as an OfficeJet® or DeskJet® from Hewlett Packard.

The general purpose storage controller 2420 connects the storage medium disk 2404 with communication bus 2422, which may be an ISA, EISA, VESA, PCI, or similar, for interconnecting all of the components of the computer 2400. A description of the general features and functionality of the display 2410, keyboard and/or mouse 2414, as well as the display controller 2408, storage controller 2420, network controller 2406, and general purpose I/O interface 2412 is omitted herein for brevity as these features are known.

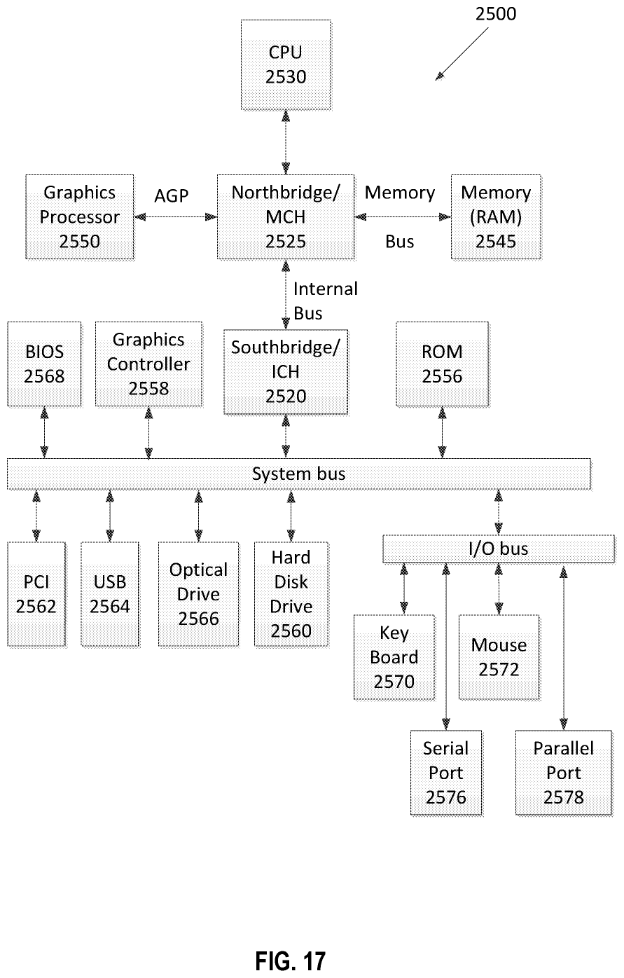

FIG. 17 is a schematic diagram of an exemplary data processing system. The data processing system is an example of a computer in which code or instructions implementing the processes of the illustrative embodiments can be located.

In FIG. 17, data processing system 2500 employs an application architecture including a north bridge and memory controller hub (NB/MCH) 2525 and a south bridge and input/output (I/O) controller hub (SB/ICH) 2520. The central processing unit (CPU) 2530 is connected to NB/MCH 2525. The NB/MCH 2525 also connects to the memory 2545 via a memory bus, and connects to the graphics processor 2550 via an accelerated graphics port (AGP). The NB/MCH 2525 also connects to the SB/ICH 2520 via an internal bus (e.g., a unified media interface or a direct media interface). The CPU 2530 can contain one or more processors and even can be implemented using one or more heterogeneous processor systems.

Referring again to FIG. 17, the data processing system 2500 can include the SB/ICH 2520 being coupled through a system bus to an I/O Bus, a read only memory (ROM) 2556, universal serial bus (USB) port 2564, a flash binary input/output system (BIOS) 2568, and a graphics controller 2558. PCI/PCIe devices can also be coupled to SB/ICH 2520 through a PCI bus 2562.

The PCI devices can include, for example, Ethernet adapters, add-in cards, and PC cards for notebook computers. The Hard disk drive 2560 and CD-ROM 2566 can use, for example, an integrated drive electronics (IDE) or serial advanced technology attachment (SATA) interface. In one implementation the I/O bus can include a super I/O (SIO) device.

Further, the hard disk drive (HDD) 2560 and optical drive 2566 can also be coupled to the SB/ICH 2520 through a system bus. In one implementation, a keyboard 2570, a mouse 2572, a parallel port 2578, and a serial port 2576 can be connected to the system bus through the I/O bus. Other peripherals and devices can be connected to the SB/ICH 2520 using a mass storage controller such as SATA or PATA, an Ethernet port, an ISA bus, a LPC bridge, SMBus, a DMA controller, and an Audio Codec.

In the preceding description, specific details have been set forth, such as a particular geometry of a processing system and descriptions of various components and processes used therein. It should be understood, however, that techniques herein may be practiced in other embodiments that depart from these specific details, and that such details are for purposes of explanation and not limitation. Embodiments disclosed herein have been described with reference to the accompanying drawings. Similarly, for purposes of explanation, specific numbers, materials, and configurations have been set forth in order to provide a thorough understanding. Nevertheless, embodiments may be practiced without such specific details. Components having substantially the same functional constructions are denoted by like reference characters, and thus any redundant descriptions may be omitted.

Various techniques have been described as multiple discrete operations to assist in understanding the various embodiments. The order of description should not be construed as to imply that these operations are necessarily order dependent. Indeed, these operations need not be performed in the order of presentation. Operations described may be performed in a different order than the described embodiment. Various additional operations may be performed and/or described operations may be omitted in additional embodiments.

“Substrate” or “target substrate” as used herein generically refers to an object being processed in accordance with the invention. The substrate may include any material portion or structure of a device, particularly a semiconductor or other electronics device, and may, for example, be a base substrate structure, such as a semiconductor wafer, reticle, or a layer on or overlying a base substrate structure such as a thin film. Thus, substrate is not limited to any particular base structure, underlying layer or overlying layer, patterned or un-patterned, but rather, is contemplated to include any such layer or base structure, and any combination of layers and/or base structures. The description may reference particular types of substrates, but this is for illustrative purposes only.

Those skilled in the art will also understand that there can be many variations made to the operations of the techniques explained above while still achieving the same objectives of the invention. Such variations are intended to be covered by the scope of this disclosure. As such, the foregoing descriptions of embodiments of the invention are not intended to be limiting. Rather, any limitations to embodiments of the invention are presented in the following claims.

Embodiments of the present disclosure may also be as set forth in the following parentheticals.
(1) An object recognition apparatus, comprising: a substrate formed of a textile; and at least one sensor including an inductive coil, the inductive coil including a conductive fiber, the inductive coil being sewn into the substrate, each of the at least one sensor configured to detect an object proximal to the at least one sensor via inductive coupling and output a signal based on a change in a resonant frequency of the at least one sensor.
(2) The apparatus of (1), further comprising: processing circuitry configured to receive, from each of the at least one sensor, the signal based on the change in resonant frequency of the respective at least one sensor; and determine, based on the signal, an identity of the object.
(3) The apparatus of (2), wherein the signal includes at least one shape-related feature and at least one material-related feature of the object.
(4) The apparatus of either (2) or (3), wherein the processing circuitry is further configured to determine the identity of the object using a trained neural network.
(5) The apparatus of (4), wherein the neural network is trained using a training dataset, the input data of the training dataset including reference signals based on the at least one shape-related feature and the at least one material-related feature of training objects measured empirically.
(6) The apparatus of any one of (2) to (5), wherein the processing circuitry is further configured to determine the identity of the object based on comparisons of the signal to the reference signals of the training dataset.
(7) The apparatus of any one of (1) to (6), wherein the substrate includes an array of a plurality of the at least one sensor.
(8) The apparatus of any one of (7), wherein the array includes 36 of the at least one sensor in a 6 by 6 grid.
(9) The apparatus of either (7) or (8), wherein each of the at least one sensor in the array detects a portion of the object and outputs respective signals based on the detected portion.
(10) The apparatus of any one of (1) to (9), wherein the textile of the substrate includes at least one of polyester, Lyocell, Nylon, Modal Rayon, Bemberg Rayon, and cotton.
(11) The apparatus of any one of (1) to (10), wherein a shape of the inductive coil is square.
(12) The apparatus of any one of (1) to (11), further comprising: a housing, including: a first insulation layer disposed over a top of the substrate and the at least one sensor; and a second insulation layer disposed below a bottom of the substrate and the at least one sensor.
(13) The apparatus of (12), further comprising: a second substrate including a second at least one sensor sewn into the second substrate, wherein the second substrate and the second at least one sensor is disposed below the first substrate and the first at least one sensor, a top of the second substrate and the second at least one sensor facing an opposite direction as the top of the first substrate and the first at least one sensor, and the first at least one sensor is electrically coupled to the second at least one sensor.
(14) The apparatus of any one of (1) to (13), wherein each of the at least one sensor includes 8 turns and has an inductance greater than 1.50 uH.
(15) A method for object recognition, the method comprising: receiving a signal from at least one sensor, the at least one sensor including an inductive coil, the inductive coil including a conductive fiber, the inductive coil being sewn into a substrate formed of a textile, each of the at least one sensor configured to detect an object proximal to the at least one sensor via inductive coupling and output a signal based on a change in a resonant frequency of the at least one sensor; and determining, based on the signal, an identity of the object, wherein the signal generated is based on the change in resonant frequency of the respective at least one sensor.
(16) The method of (15), wherein the signal includes at least one shape-related feature and at least one material-related feature of the object.
(17) The method of (16), wherein determining the identity of the object utilizes a trained neural network.
(18) The method of (17), further comprising training the neural network using a training dataset, the input data of the training dataset including reference signals based on the at least one shape-related feature and the at least one material-related feature of training objects measured empirically.
(19) The method of (18), wherein the step of determining the identity of the object comprises determining the identity of the object based on comparisons of the signal to the reference signals of the training dataset.
(20) A non-transitory computer readable storage medium including executable instructions, wherein the instructions, when executed by circuitry, cause the circuitry to perform the method according to any one of (15) to (19).

The following provide supplementary description for the work described herein. The following are hereby incorporated by reference in their entirety:
TI LDC Sensor Design Application Report SNOA930. 2015. Retrieved Mar. 15, 2019 from http://www.ti.com/lit/an/snoa930a/snoa930a.pdf
Eugen Berlin, Jun Liu, Kristof van Laerhoven and Bernt Schiele. 2010. Coming to grips with the objects we grasp: detecting interactions with efficient wrist-worn sensors. In Proceedings of the fourth international conference on Tangible, embedded, and embodied interaction (TEI'10), 57-64.
Michael Boyle and Saul Greenberg. 2005. The language of privacy: Learning from video media space analysis and design. ACM Trans. Comput.-Hum. Interact., 12 (2). 328-370. DOI=http://dx.doi.org /10.1145/1067860.1067868
Leah Buechley and Michael Eisenberg. 2009. Fabric PCBs, electronic sequins, and socket buttons: techniques for e-textile craft. Personal Ubiquitous Comput., 13 (2). 133-150. DOI=https://doi.org/10.1007/s00779-007-0181-0
Michael Buettner, Richa Prasad, Matthai Philipose and David Wetherall. 2009. Recognizing daily activities with RFID-based sensors. In Proceedings of the 11th international conference on Ubiquitous computing (UbiComp'09), 51-60. DOI=http://doi.acm.org/10.1145/1620545.1620553
erumal Varun Chadalavada, Goutham Palaniappan, Vimal Kumar Chandran, Khai Truong and Daniel Wigdor. 2018. ID'em: Inductive Sensing for Embedding and Extracting Information in Robust Materials. In Proceedings of the ACM on Interactive, Mobile, Wearable and Ubiquitous Technologies, 2 (3). 1-28. DOI=https://doi.org/10.1145/3264907
Liwei Chan, Yi-Ling Chen, Chi-Hao Hsieh, Rong-Hao Liang and Bing-Yu Chen. 2015. CyclopsRing: Enabling Whole-Hand and Context-Aware Interactions Through a Fisheye Ring. In Proceedings of the 28th Annual ACM Symposium on User Interface Software and Technology, 549-556. DOI=https://doi.org/10.1145/2807442.2807450
Kai-Yin Cheng, Rong-Hao Liang, Bing-Yu Chen, Rung-Huei Laing and Sy-Yen Kuo. 2010. iCon: utilizing everyday objects as additional, auxiliary and instant tabletop controllers. In Proceedings of the SIGCHI Conference on Human Factors in Computing Systems (CHI'10), 1155-1164. DOI=https://doi.org/10.1145/1753326.1753499
Kunigunde Cherenack, Christoph Zysset, Thomas Kinkeldei, Niko Miinzenrieder and Gerhard Troster. 2010. Woven Electronic Fibers with Sensing and Display Functions for Smart Textiles. Advanced Materials, 22 (45). 5178-5182. DOI=https://doi.org/10.1002/adma.201002159
Lucy E. Dunne, Kaila Bibeau, Lucie Mulligan, Ashton Frith and Cory Simon. 2012. Multi-layer e-textile circuits. In Proceedings of the 2012 ACM Conference on Ubiquitous Computing (UbiComp'12), 649-650. DOI=http://dx.doi.org/10.1145/2370216.2370348
Jun Gong, Xin Yang, Teddy Seyed, Josh Urban Davis and Xing-Dong Yang. 2018. Indutivo: Contact-Based, Object-Driven Interactions with Inductive Sensing. In Proceedings of the 31st Annual ACM Symposium on User Interface Software and Technology (UIST'18), 321-333. DOI=https://doi.org/10.1145/3242587.3242662
Tobias Grosse-Puppendahl, Sebastian Herber, Raphael Wimmer, Frank Englert, Sebastian Beck, Julian von Wilmsdorff, Reiner Wichert and Arjan Kuijper. 2014. Capacitive near-field communication for ubiquitous interaction and perception. In Proceedings of the 2014 ACM International Joint Conference on Pervasive and Ubiquitous Computing (UbiComp'14), 231-242. DOI=https://doi.org/10.1145/2632048.2632053
Sunao Hashimoto, Ryohei Suzuki, Youichi Kamiyama, Masahiko Inami and Takeo Igarashi. 2013. LightCloth: senseable illuminating optical fiber cloth for creating interactive surfaces. In CHI'13 Extended Abstracts on Human Factors in Computing Systems (CHI EA'13), 2809-2810. DOI=https://doi.org/10.1145/2468356.2479523
Gerard J. Hayes, Ying Liu, Jan Genzer, Gianluca Lazzi and Michael D. Dickey. 2014. Self-Folding Origami Microstrip Antennas. IEEE Transactions on Antennas and Propagation, 62 (10). 5416-5419. DOI=https://doi.org/10.1109/TAP.2014.2346188
Steve Hodges, Alan Thorne, Hugo Mallinson and Christian Floerkemeier. 2007. Assessing and optimizing the range of UHF RFID to enable real-world pervasive computing applications. In International Conference on Pervasive Computing, 280-297. DOI=https://doi.org/10.1007/978-3-540-72037-9_17
David I Lehn, Craig W Neely, Kevin Schoonover, Thomas L Martin and Mark Jones. 2004. e-TAGs: e-textile attached gadgets. In Proceedings of the Communication Networks and Distributed Systems Modeling and Simulation Conference.
Hiren Galiyawala Kinjal H. Pandya. 2014. A Survey on QR Codes: in context of Research and Application. International Journal of Emerging Technology and Advanced Engineering. 4 (3). 258-262.
Gierad Laput, Robert Xiao and Chris Harrison. 2016. Viband: High-fidelity bio-acoustic sensing using commodity smartwatch accelerometers. In Proceedings of the 29th Annual Symposium on User Interface Software and Technology (UIST'16), 321-333. DOI=https://doi.org/10.1145/2984511.2984582
Gierad Laput, Chouchang Yang, Robert Xiao, Alanson Sample and Chris Harrison. 2015. Em-sense: Touch recognition of uninstrumented, electrical and electromechanical objects. In Proceedings of the 28th Annual ACM Symposium on User Interface Software and Technology (UIST'15), 157-166. DOI=https://doi.org/10.1145/2807442.2807481
Joanne Leong, Patrick Parzer, Florian Perteneder, Teo Babic, Christian Rendl, Anita Vogl, Hubert Egger, Alex Olwal and Michael Haller. 2016. proCover: Sensory Augmentation of Prosthetic Limbs Using Smart Textile Covers. In Proceedings of the 29th Annual Symposium on User Interface Software and Technology (UIST'16), 335-346. DOI=https://doi.org/10.1145/2984511.2984572
Hanchuan Li, Eric Brockmeyer, Elizabeth J. Carter, Josh Fromm, Scott E. Hudson, Shwetak N. Patel and Alanson Sample. 2016. PaperID: A Technique for Drawing Functional Battery-Free Wireless Interfaces on Paper. In Proceedings of the 2016 CHI Conference on Human Factors in Computing Systems (CHI'16), 5885-5896. DOI=https://doi.org/10.1145/2858036.2858249
Hanchuan Li, Can Ye and Alanson P. Sample. 2015. IDSense: A Human Object Interaction Detection System Based on Passive UHF RFID. In Proceedings of the 33rd Annual ACM Conference on Human Factors in Computing Systems (CHI'15), 2555-2564. DOI=https://doi.org/10.1145/2702123.2702178
Jaime Lien, Nicholas Gillian, M. Emre Karagozler, Patrick Amihood, Carsten Schwesig, Erik Olson, Hakim Raja and Ivan Poupyrev. 2016. Soli: Ubiquitous Gesture Sensing with Millimeter Wave Radar. In ACM Transactions on Graphics (SIGGRAPH'16). DOI=https://doi.org/10.1145/2897824.2925953
David G. Lowe. 1999. Object recognition from local scale-invariant features. In Proceedings of the Seventh IEEE International Conference on Computer Vision (ICCV'99), 1150-1157. DOI=https://doi.org/10.1109/ICCV.1999.790410
Takuya Maekawa, Yasue Kishino, Yutaka Yanagisawa and Yasushi Sakurai. 2012. Recognizing handheld electrical device usage with hand-worn coil of wire. In International Conference on Pervasive Computing (Pervasive'12), 234-252. DOI=https://doi.org/10.1007/978-3-642-31205-2_15
Jan Meyer, Bert Arnrich, Johannes Schumm and Gerhard Troster. 2010. Design and Modeling of a Textile Pressure Sensor for Sitting Posture Classification. IEEE Sensors Journal, 10 (8). 1391-1398. DOI=https://doi.org/10.1109/JSEN.2009.2037330
Norhisam Misron, Loo Qian Ying, Raja Nor Firdaus, Norrimah Abdullah, Nashiren Farzilah Mailah and Hiroyuki Wakiwaka. 2011. Effect of inductive coil shape on sensing performance of linear displacement sensor using thin inductive coil and pattern guide. Sensors, 11 (11). 10522-10533. DOI=https://doi.org/10.3390/s111110522
Sunderarajan S Mohan, Maria del Mar Hershenson, Stephen P Boyd and Thomas H Lee. 1999. Simple accurate expressions for planar spiral inductances. IEEE Journal of solid-state circuits, 34 (10). 1419-1424. DOI=https://doi.org/10.1109/4.792620
David S. Nyce. Inductive Sensing. In Linear Position Sensors. 78-93. DOI=https://doi.org/10.1002/0471474282
Patrick Parzer, Florian Perteneder, Kathrin Probst, Christian Rendl, Joanne Leong, Sarah Schuetz, Anita Vogl, Reinhard Schwoediauer, Martin Kaltenbrunner, Siegfried Bauer and Michael Haller. 2018. RESi: A Highly Flexible, Pressure-Sensitive, Imperceptible Textile Interface Based on Resistive Yarns. In Proceedings of the 31st Annual ACM Symposium on User Interface Software and Technology (UIST'18), 745-756. DOI=https://doi.org/10.1145/3242587.3242664
Patrick Parzer, Kathrin Probst, Teo Babic, Christian Rendl, Anita Vogl, Alex Olwal and Michael Haller. 2016. FlexTiles: A Flexible, Stretchable, Formable, Pressure-Sensitive, Tactile Input Sensor. In Proceedings of the 2016 CHI Conference Extended Abstracts on Human Factors in Computing Systems (CHI EA'16), 3754-3757. DOI=https://doi.org/10.1145/2851581.2890253
Patrick Parzer, Adwait Sharma, Anita Vogl, Jurgen Steimle, Alex Olwal and Michael Haller. 2017. SmartSleeve: Real-time Sensing of Surface and Deformation Gestures on Flexible, Interactive Textiles, using a Hybrid Gesture Detection Pipeline. In Proceedings of the 30th Annual ACM Symposium on User Interface Software and Technology (UIST'17), 565-577. DOI=https://doi.org/10.1145/3126594.3126652
Vesa Peltonen, Juha Tuomi, Anssi Klapuri, Jyri Huopaniemi and Timo Sorsa. 2002. Computational auditory scene recognition. In IEEE International Conference on Acoustics, Speech, and Signal Processing (ICASSP'02), 11-1941-11-1944. DOI=https://doi.org/10.1109/ICASSP.2002.5745009
Alex “Sandy” Pentland. 1998. Wearable Intelligence. Scientific American, 90-95.
Ivan Poupyrev, Nan-Wei Gong, Shiho Fukuhara, Mustafa Emre Karagozler, Carsten Schwesig and Karen E. Robinson. 2016. Project Jacquard: Interactive Digital Textiles at Scale. In Proceedings of the 2016 CHI Conference on Human Factors in Computing Systems (CHI'16), 4216-4227. DOI=https://doi.org/10.1145/2858036.2858176
Juhi Ranjan, Yu Yao, Erin Griffiths and Kamin Whitehouse. 2012. Using mid-range RFID for location based activity recognition. In Proceedings of the 2012 ACM Conference on Ubiquitous Computing (UbiComp'12), 647-648. DOI=http://dx.doi.org/10.1145/2370216.2370347
Mahsan Rofouei, Wenyao Xu and Majid Sarrafzadeh. 2010. Computing with uncertainty in a smart textile surface for object recognition. In 2010 IEEE Conference on Multisensor Fusion and Integration, 174-179. DOI=http://dx.doi.org/10.1109/MFI.2010.5604473
Edward B. Rosa. 1906. Calculation of the self-inductances of single-layer coils. Bull. Bureau Standards, 2 (2). 161-187.
Edward Bennett Rosa. 1908. The self and mutual inductances of linear conductors.
Stefan Schneegass and Alexandra Voit. 2016. GestureSleeve: using touch sensitive fabrics for gestural input on the forearm for controlling smartwatches. In Proceedings of the 2016 ACM International Symposium on Wearable Computers (ISWC '16), 108-115. DOI=https://doi.org/10.1145/2971763.2971797
Jamie Shotton, Andrew Fitzgibbon, Mat Cook, Toby Sharp, Mark Finocchio, Richard Moore, Alex Kipman and Andrew Blake. 2011. Real-time human pose recognition in parts from single depth images. In Conference on Computer Vision and Pattern Recognition (CVPR'11), 1297-1304. DOI=https://doi.org/10.1109/CVPR.2011.5995316
Joshua R Smith, Kenneth P Fishkin, Bing Jiang, Alexander Mamishev, Matthai Philipose, Adam D Rea, Sumit Roy and Kishore Sundara-Rajan. 2005. RFID-based techniques for human-activity detection. Communications of the ACM, 48 (9). 39-44. DOI=http://dx.doi.org/10.1145/1081992.1082018
Jie Song, Gabor Soros, Fabrizio Pece, Sean Ryan Fanello, Shahram Izadi, Cem Keskin, and Otmar Hilliges. 2014. In-air gestures around unmodified mobile devices. In Proceedings of the 27th annual ACM symposium on User interface software and technology (UIST '14), 319-329. DOI=https://doi.org/10.1145/2642918.2647373
Michael E. Van Steenberg, Andrew Washabaugh, and Neil Goldfme. 2001. Inductive and capacitive sensor arrays for in situ composition sensors. In Proceedings of 2001 IEEE Aerospace Conference. DOI=https://doi.org/10.1109/AER0.2001.931721
Yuta Sugiura, Gota Kakehi, Anusha Withana, Calista Lee, Daisuke Sakamoto, Maki Sugimoto, Masahiko Inami and Takeo Igarashi. 2011. Detecting shape deformation of soft objects using directional photoreflectivity measurement. In Proceedings of the 24th annual ACM symposium on User interface software and technology (UIST'11), 509-516. DOI=https://doi.org/10.1145/2047196.2047263
Nalika Ulapane, Linh Nguyen, Jaime Valls Miro, Alen Alempijevic and Gamini Dissanayake. 2017. Designing a pulsed eddy current sensing set-up for cast iron thickness assessment. In 12th IEEE Conference on Industrial Electronics and Applications (ICIEA'17), 901-906. DOI=https://doi.org/10.1109/ICIEA.2017.8282967
Nicolas Villar, Daniel Cletheroe, Greg Saul, Christian Holz, Tim Regan, Oscar Salandin, Misha Sra, Hui-Shyong Yeo, William Field and Haiyan Zhang. 2018. Project Zanzibar: A Portable and Flexible Tangible Interaction Platform. In Proceedings of the 2018 CHI Conference on Human Factors in Computing Systems. DOI=https://doi.org/10.1145/3173574.3174089
Anita Vogl, Patrick Parzer, Teo Babic, Joanne Leong, Alex Olwal and Michael Haller. 2017. StretchEBand: Enabling Fabric-based Interactions through Rapid Fabrication of Textile Stretch Sensors. In Proceedings of the 2017 CHI Conference on Human Factors in Computing Systems (CHI'17), 2617-2627. DOI=https://doi.org/10.1145/3025453.3025938
Edward J Wang, Tien-Jui Lee, Alex Mariakakis, Mayank Goel, Sidhant Gupta and Shwetak N Patel. 2015. Magnifisense: Inferring device interaction using wrist-worn passive magneto-inductive sensors. In Proceedings of the 2015 ACM International Joint Conference on Pervasive and Ubiquitous Computing (UbiComp'15), 15-26. DOI=https://doi.org/10.1145/2750858.2804271

Jamie A Ward, Paul Lukowicz, Gerhard Troster and Thad E Starner. 2006. Activity recognition of assembly tasks using body-worn microphones and accelerometers. IEEE transactions on pattern analysis and machine intelligence, 28 (10). 1553-1567. DOI=https://doi.org/10.1109/TPAMI.2006.197
Robert Xiao, Gierad Laput, Yang Zhang and Chris Harrison. 2017. Deus EM Machina: on-touch contextual functionality for smart IoT appliances. In Proceedings of the 2017 CHI Conference on Human Factors in Computing Systems (CHI'17), 4000-4008. DOI=https://doi.org/10.1145/3025453.3025828
Wenyao Xu, Ming-Chun Huang, Navid Amini, Lei He and Majid Sarrafzadeh. 2013. eCushion: A Textile Pressure Sensor Array Design and Calibration for Sitting Posture Analysis.IEEE Sensors Journal, 13 (10). 3926-3934. DOI=https://doi.org/10.1109/JSEN.2013.2259589
Hui-Shyong Yeo, Gergely Flamich, Patrick Schrempf, David Harris-Birtill and Aaron Quigley. 2016. Radarcat: Radar categorization for input and interaction. In Proceedings of the 29th Annual Symposium on User Interface Software and Technology (UIST'16), 833-841. DOI=https://doi.org/10.1145/2984511.2984515
Jonsenser Zhao. 2010. A new calculation for designing multilayer planar spiral inductors. EDN (Electrical Design News), 55 (14). 37.

1. An object recognition apparatus, comprising:
a substrate formed of a textile; and
at least one sensor including an inductive coil, the inductive coil including a conductive fiber, the inductive coil being sewn into the substrate, each of the at least one sensor configured to detect an object proximal to the at least one sensor via inductive coupling and output a signal based on a change in a resonant frequency of the at least one sensor.

2. The apparatus of claim 1, further comprising:
processing circuitry configured to
receive, from each of the at least one sensor, the signal based on the change in resonant frequency of the respective at least one sensor; and
determine, based on the signal, an identity of the object.

3. The apparatus of claim 2, wherein the signal includes at least one shape-related feature and at least one material-related feature of the object.

4. The apparatus of claim 3, wherein the processing circuitry is further configured to determine the identity of the object using a trained neural network.

5. The apparatus of claim 4, wherein the neural network is trained using a training dataset, the input data of the training dataset including reference signals based on the at least one shape-related feature and the at least one material-related feature of training objects measured empirically.

6. The apparatus of claim 5, wherein the processing circuitry is further configured to determine the identity of the object based on comparisons of the signal to the reference signals of the training dataset.

7. The apparatus of claim 1, wherein the substrate includes an array of a plurality of the at least one sensor.

8. The apparatus of claim 7, wherein the array includes 36 of the at least one sensor in a 6 by 6 grid.

9. The apparatus of claim 7, wherein each of the at least one sensor in the array detects a portion of the object and outputs respective signals based on the detected portion.

10. The apparatus of claim 1, wherein the textile of the substrate includes at least one of polyester, Lyocell, Nylon, Modal Rayon, Bemberg Rayon, and cotton.

11. The apparatus of claim 1, wherein a shape of the inductive coil is square.

12. The apparatus of claim 1, further comprising:
a housing, including:
a first insulation layer disposed over a top of the substrate and the at least one sensor; and
a second insulation layer disposed below a bottom of the substrate and the at least one sensor.

13. The apparatus of claim 12, further comprising:
a second substrate including a second at least one sensor sewn into the second substrate, wherein
the second substrate and the second at least one sensor is disposed below the first substrate and the first at least one sensor, a top of the second substrate and the second at least one sensor facing an opposite direction as the top of the first substrate and the first at least one sensor, and
the first at least one sensor is electrically coupled to the second at least one sensor.

14. The apparatus of claim 1, wherein each of the at least one sensor includes 8 turns and has an inductance greater than 1.50 uH.

15. A method for object recognition, the method comprising:
receiving a signal from at least one sensor, the at least one sensor including an inductive coil, the inductive coil including a conductive fiber, the inductive coil being sewn into a substrate formed of a textile, each of the at least one sensor configured to detect an object proximal to the at least one sensor via inductive coupling and output a signal based on a change in a resonant frequency of the at least one sensor; and
determining, based on the signal, an identity of the object, wherein
the signal generated is based on the change in resonant frequency of the respective at least one sensor.

16. The method of claim 15, wherein the signal includes at least one shape-related feature and at least one material-related feature of the object.

17. The method of claim 16, wherein determining the identity of the object utilizes a trained neural network.

18. The method of claim 17, further comprising training the neural network using a training dataset, the input data of the training dataset including reference signals based on the at least one shape-related feature and the at least one material-related feature of training objects measured empirically.

19. The method of claim 18, wherein the step of determining the identity of the object comprises determining the identity of the object based on comparisons of the signal to the reference signals of the training dataset.

20. A non-transitory computer readable storage medium including executable instructions, wherein the instructions, when executed by circuitry, cause the circuitry to perform the method according to claim 15.
